(19) United States
(12) Patent Application Publication
(10) Pub. No.: US 2024/0044135 A1
(43) Pub. Date: Feb. 8, 2024

(54) Retractable Roof

(71) Applicant: Volco Inc., Brantford (CA)

(72) Inventors: Richard VOLLEBREGT, Brantford (CA); Wayne LICKERS, Brantford (CA); Shane William LEWIS, Cambridge (CA); Jeff DRABBLE, Brantford (CA); Graham MCDONALD, Brantford (CA)

(21) Appl. No.: 18/446,297

(22) Filed: Aug. 8, 2023

Related U.S. Application Data
(60) Provisional application No. 63/396,062, filed on Aug. 8, 2022.
(60) Provisional application No. 63/419,656, filed on Oct. 26, 2022.
(60) Provisional application No. 63/516,010, filed on Jul. 27, 2023.

(51) Int. Cl. E04B 7/16; A01G 9/24

(52) U.S. Cl. CPC E04B 7/166; A01G 9/241

(57) ABSTRACT

A retractable roof structure has a pair of longitudinally spaced supports, guide wires extending between said supports and positioned to support a covering in a required profile. The covering comprises a plurality of sections arranged in seriatim along the guide wires with each section slidably supported on the guide wires so as to be moveable between an open position in which the area beneath the covering is exposed and a closed position in which the area beneath the covering is covered. A drive member extends between the supports and is connected to one end of each of the sections at a first location to move the one end along the guide wires. A tensile member, such as a rope or cable, extends from the peak of the leading edge of one section to the lower corner of the leading edge of a section along a path so that movement of the peak is transmitted by the tensile member to the eaves to move the section along the eave guide wire in the same direction.

### FIELD OF THE INVENTION

The present invention relates to a retractable roof.

### DESCRIPTION OF THE PRIOR ART

Retractable roofs are used in a variety of applications, such as sport stadiums, storage facilities and for protection of crops as they grow. The ability to cover and uncover an area enables the ambient conditions beneath the roof to be adjusted and mitigate adverse effects of the environment, such as excessive heat or rain. This is particularly important in horticultural applications where an unexpected weather event can cause serious damage or loss of a crop.

Conventionally, crop protection has been provided by glasshouses which are large permanent structures. They are therefore expensive to build and maintain.

An alternative type of structure is that exemplified in U.S. Pat. No. 5,265,373 issued to Richard Vollebregt in which crop protection is provided by curtains that can be extended and retracted along support wires to adjust the protection afforded to the crop.

U.S. Pat. No. 5,513,470 to Richard Vollebregt shows a crop protection structure in which gables provide support for a ridged curtain system that emulates a conventional greenhouse structure. The gables support curtains that extend across the peaks and through the valleys. The curtains can be extended or retracted by a driven cable to vary the protection provided. The cables are connected to a drive system that includes a rotating shaft that extends along the gable to provide multiple locations to which cables can be connected to the curtains.

Because of the pitched nature of the roof, the drive shafts incorporate universal couplings and more than one drive shaft may be used along the length of the structure. The substantial nature of the gables provides a durable and versatile structure but the complexity of the drive system is relatively expensive and complicated to install. The cost is justified where intensive horticultural practices are concerned with multiple high value crops per growing season.

In order to reduce the overall cost of installation an alternative support structure is shown in U.S. Pat. No. 9,163,401 to Richard Vollebregt where posts and tensioned cables are utilised to provide the gables and support a gutter that collects the rainwater. This allows the structure to be installed on land that is not level and significantly reduces the cost of materials whilst maintaining the versatility. However, for certain applications, the high cost still cannot be justified.

For example, crops like cherries and grapes need to be grown outside since they need cold temperatures in the winter time and need exposure to the natural outdoors to create firm, sweet fruit. Such crops need protection from rain primarily during the last several weeks just prior to harvest to prevent splitting of fruit and maintain the quality to attain the highest available price. Automatic retractable roof systems such as those discussed above can protect plants from cold, heat, wind, rain, hail and are cost effective on crops like vegetables which need protection from rain 12 months per year. However a retractable roof system like those described above is cost prohibitive for crops that only have one harvest of fruit per year (i.e. cherries, grapes) since the value of the crop per hectare is much lower than crops that have multiple harvests over many months. Moreover, the value of the rain shedding capabilities only starts in year 3 when cherry trees start to produce fruit. In addition, crops like cherries can tolerate having rain fall in between the rows of trees as long as the rain does not fall on the tree or fruit whereas crops like vegetables need a gutter system below the retractable roof to catch the rainfall from the valley since the crops cover most of the area beneath the roof.

Where permanent retractable systems cannot be justified, seasonally installed protective coverings may be utilised. Such coverings are manually installed early in the season and are used to advance flowers and protect from frost, wind, sunburn and rain prior to harvest. The covering must be in tension (taut) to minimize flapping since movement of the covering causes failure due to fatigue. It also takes significant manpower to install and remove.

Whilst the seasonal covering may provide for protection from extreme weather events over the growing season, the covering changes the climate in negative ways compared to a natural environment, resulting in softer fruit that is less sweet and has a shorter shelf life. The openings between the lower edges of the curtains allow for continual air exchange between the areas below and above the covering which prevents protection from cold air temperatures. Openings between the coverings mean that the covering cannot be used to raise temperatures like a greenhouse or trap supplemental heat to accelerate the spring flowering.

Movable rain coverings intended to protect crops during the critical period prior to harvest rather than protection over the whole growing season have been proposed where the coverings are slidably supported on guide wires and can be deployed selectively depending on weather conditions. Some proposals require manual deployment using long sticks or ropes, but this is time consuming and can result in crops not being protected in time before adverse weather arrives, resulting in damage to the covering or fruit.

Rain coverings have also been proposed that are moved with a drive system powered by a rope or cable at the peak that is powered by motor and gearbox or portable drill. The major advantage of a powered system is that the coverings can be closed quickly when rain or hail is approaching to prevent damage to the fruit however the roofs on each set of peaks are operated individually which takes more time and reduces that chance that the covers are deployed or retracted in time.

To be able to move the covering when it is only powered at the peak, the covering must be loose so that there is minimal friction between the plastic hooks that connect the covering to the supporting wires or cables. However, lose fabric will flap in the wind causing fatigue to the covering over time and therefore a shorter life.

To move a covering, an economical way is to have a drive cable at the peak and drag the rain cover panel closed. This causes the lower edge to drag behind which then necessitates that the covering needs to be flexible so that it can easily pleat. This is accomplished by not installing any additional reinforcing or stiffening at the grommet location.

In such an arrangement, the peak of the covering is powered but the lower edge is not powered causing the covering at the valley to lag behind the peak position. This causes sections of the roof to not be completely closed allowing rain to enter and damage the fruit or for heat to escape. In order to ensure a proper closing and retracting of the rain cover it is necessary to power the covering both at the upper and lower edges of the covering. To do that, a drive shaft would need to have universal joints to allow it to follow the profile of the roof so that one motor can power multiple coverings. This adds to the cost and complexity for installation and maintenance especially when covering fields with rolling grades.

One covering system marketed by Valenti under the trade name Wayki (https://valentepali.com/en/orchard/orchard-coverings/antirain/multishield/wayki) uses a drive cable at the peak to move panels of the rain cover sequentially. A hook engages the rain cover panel at the peak as it passes a support and releases it as it gets to the next support. This system has the advantage of being a simple system however it still requires the lower edges to slide freely along the wire and because it releases the panel as it moves along, it does not ensure the covering remains in a fixed position. A strong wind can blow a closed cover open or an open cover closed.

It is an object of the present invention to provide a retractable roof in which the above disadvantages may be obviated or mitigated.

### SUMMARY OF THE INVENTION

According to one aspect of the invention there is provided a retractable roof structure having a pair of longitudinally spaced supports, guide wires extending between said supports and positioned to support a covering in a required profile, said covering comprising a plurality of sections arranged in seriatim along the guide wires with each section slidably supported on the guide wires so as to be moveable between an open position in which the area beneath the covering is exposed and a closed position in which the area beneath the covering is covered, a drive member extending between the supports and operably connected to one end of each of the sections at a first location to move the one end along the guide wires, and a first tensile member extending between said first location and a second location on another of said sections spaced from said first location and operably connected to said drive member to move said second location conjointly with said first location, whereby movement of the first location of one section is transferred through the tensile member to the second location of the other section to cause a corresponding movement.

Preferably each of said locations is adjacent a respective one of the guide wires.

As a further preference, a second tensile member extends from the first location on the other section to a second location on the one end of the one section.

Still further, the required profile is a ridged profile having an elevated peak extending outwardly and downwardly to a pair of eaves and the guide wires are located at the peak and at the eaves to constrain the covering to the required profile.

### BRIEF DESCRIPTION OF THE DRAWINGS

Embodiments of the invention will now be described with reference to the accompanying drawings in which:

FIG. 1 is a perspective view of a retractable roof structure showing a covering in an open position;

FIG. 2 is a perspective view similar to FIG. 1 showing a covering in a closed position;

FIG. 3 is a view on the line III-III of FIG. 2;

FIG. 4 is a rear perspective of a drive system used on the roof structure of FIG. 1;

FIG. 5 is a top perspective view of an opposite end of the roof structure of FIG. 1 to that shown in FIG. 4;

FIG. 6 is a view similar to FIG. 5 of an intermediate portion of the roof structure of FIG. 1;

FIG. 7 is an enlarged perspective view of the connection of the covering to the drive system;

FIG. 8 is a perspective view showing the connection of the covering to guide wires at the eaves of the covering;

FIG. 9 is a rear perspective view showing the covering in a deployed, closed position adjacent to the drive system;

FIG. 10 is a view similar to FIG. 9 showing the covering in a retracted, open position;

FIG. 11 is a view similar to that of FIG. 9 at the opposite end of the roof structure;

FIG. 12 is a view similar to FIG. 10 at the opposite end of the roof structure;

FIG. 13 is a plan view of the roof structure of FIG. 1 showing operation in moving to the deployed, closed position;

FIG. 14 is a plan view of the roof structure of FIG. 1 showing operation in moving to the deployed, closed position;

FIG. 15 is a schematic representation of a cable run shown in FIG. 14;

FIG. 16 is an enlarged sectional view of an edge of one of the covers;

FIG. 17 is a view similar to FIG. 2 of an alternative embodiment;

FIG. 18 is a perspective view similar to FIG. 1 of a further alternative embodiment of roof structure;

FIG. 18A is an enlarged view of the portion of FIG. 18 within the circle A;

FIG. 19 is a side view of the roof structure of FIG. 18 in a deployed or closed position;

FIG. 20 is a side view similar to FIG. 19 of the roof structure in an open position;

FIG. 20A is an enlarged view of the portion of FIG. 20 within the circle B;

FIG. 21 is a plan view of the roof structure of FIG. 18 showing movement to a deployed, closed position;

FIG. 22 is a view similar to FIG. 21 showing movement to an open position;

FIG. 23 is a perspective view of tensioning system used with the drive member shown in FIG. 18;

FIG. 24 is a view similar to FIG. 23 of an alternative tensioning system;

FIG. 25 is an end view of the roof structure of FIG. 18;

FIG. 26 is a perspective view of the attachment of the roof panels of the embodiment of FIG. 18 to the drive system;

FIG. 27 is a schematic representation of water flow from the roof structure of FIG. 18 in two alternative configurations;

FIG. 28 is a perspective view of the roof panel in a first of the configurations of FIG. 27;

FIG. 29 is a perspective view of the roof panels in the second configuration shown in FIG. 27;

FIG. 30 is a perspective view of a support structure for the drive shown in FIG. 18;

FIG. 30A is an enlarged view of the circled portion of FIG. 30;

FIG. 31 is an end view of a still further embodiment of drive system for a roof structure;

FIG. 32 is a side schematic view similar to FIG. 19 of a yet further embodiment of roof structure;

FIG. 33 is a side view of a portion of the structure shown in FIG. 32 on an enlarged scale;

FIG. 34 is a side view of a further portion of the roof structure of FIG. 32 on an enlarged scale;

FIG. 35 is a further side view of the portion of roof structure shown in FIG. 33 on an enlarged scale;

FIG. 36 is a perspective view of a cable run and associated guide at one end of the roof structure;

FIG. 37 is an enlarged view of FIG. 36;

FIG. 38 is an enlarged view of a lower portion FIG. 36;

FIG. 39 is an end view of the roof structure;

FIG. 40 is an enlarged view of a cable guide shown on FIG. 39, and

FIG. 41 is an enlarged view of a roof support shown on FIG. 40.

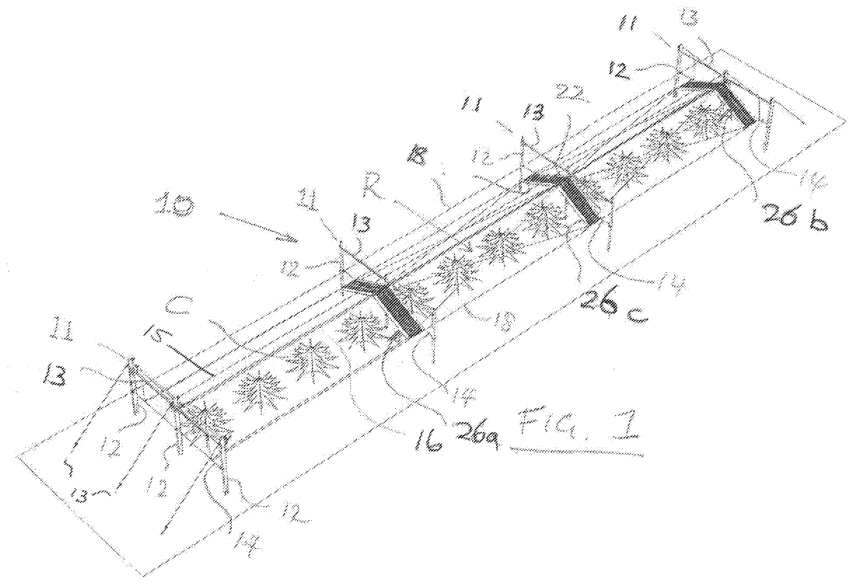

Referring firstly to FIG. 1, a retractable roof structure generally indicated as 10 is used to protect crops C. The crops C are arranged in rows R, typically oriented north to south for optimum exposure to sun and the roof structure 10 is dimensioned to extend over a row R of the crop C. The crop C may be a ground crop, such as strawberries, a vine crop such as grapes or a tree crop such as cherries and the roof structure 10 will be dimensioned accordingly. Multiple rows R may be arranged side by side with a roof structure 10 protecting each row R. For clarity the roof structure 10 associated with only one of the rows R will be described but it will be appreciated that where there are multiple rows the support structures and drive system may be shared between the rows. Likewise, multiple roof structures 10, each with multiple rows R may be positioned side by side with each roof structure having its own drive system.

The roof structure 10 comprises support structures 11 positioned at regular intervals along the row R to define a number of bays B for each row R. A spacing of the supports 11 of four metres is typical but different spacing may be used depending on the particular site and application.

Each of the support structures 11 includes three laterally spaced posts 12. Lateral wires 14 are spaced apart vertically and extend horizontally between the posts 12 of each support structure 11. One of the lateral wires 14 is positioned at the top of the posts 12 and the other lateral wire 14 is spaced approximately one third of the height of the post below the upper lateral wire, depending on the crop being protected. Where multiple rows R are to be protected the wires 14 may extend across the whole of the growing area. The height of the upper wire 14 will depend on the crop C but a height of 3.5 metres is typical.

Where a single row R is to be protected, the wires 14 may be replaced by a rigid arm to define the lateral extent of the roof structure 10. Again, this will depend on the crop C but an overall length of the arm of three metres is typical, 1.5 metres to each side of the post 12 with the arm 3.5 metres above the ground.

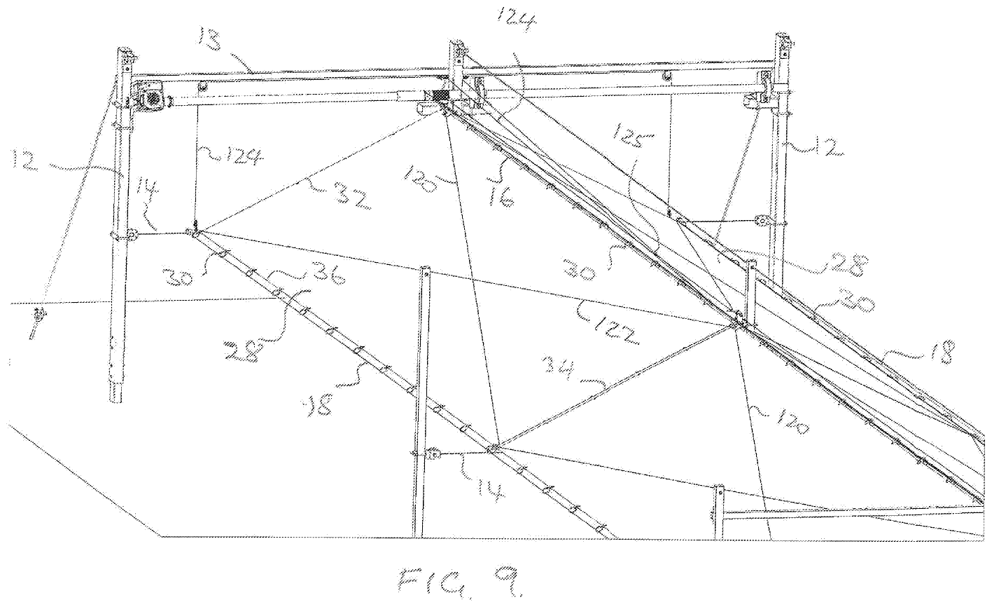

The posts 12 are stabilised by tie wires and ground anchors 13 and a stabiliser wire 15 extends between the top of the central posts 12 to transfer loads between support structures 11 of the same row R. The horizontal wires 14 are tensioned by tensioners 17 (FIG. 9) mounted on the outer of the posts 12.

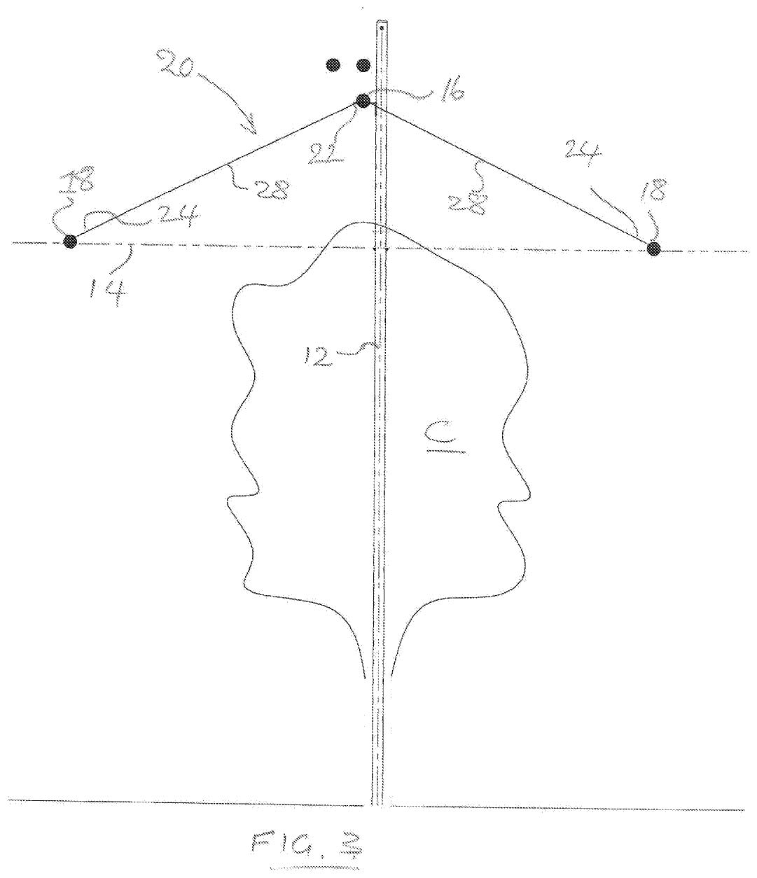

A ridge guide wire 16 extends between the upper ends of the central post 12 and is connected to each of the posts 12 as will be described in greater detail below. Eave guide wires 18 extend between the lower lateral wires 14 and are connected to lateral wires 14 at the lateral extent of the row R, typically 1.5 metres to either side of the central post 12. The guide wires 16, 18 are used to support a covering 20 in the required profile, which in this case is a ridged profile having a peak 22 and eaves 24 as best seen in FIG. 3.

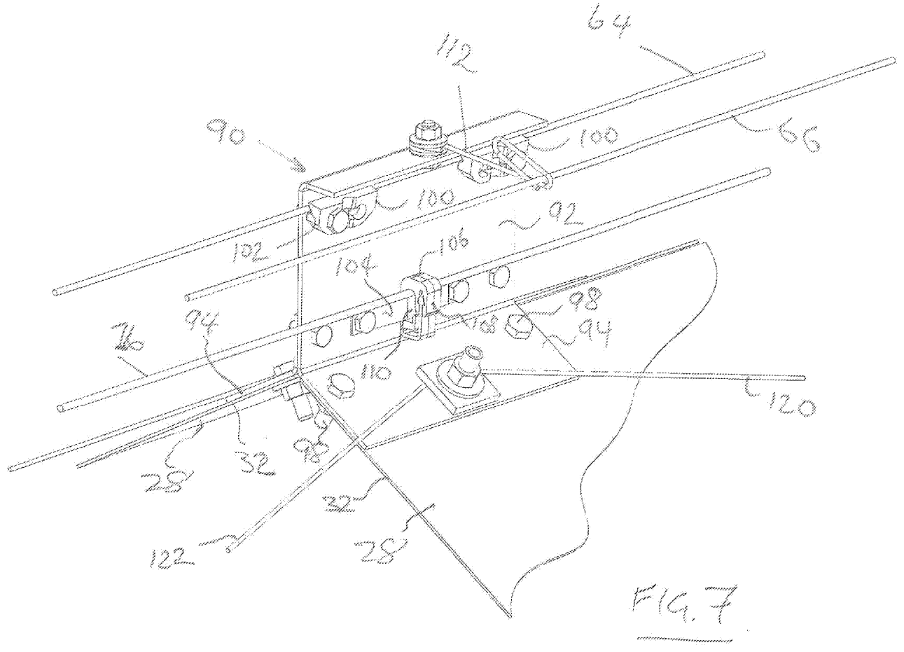

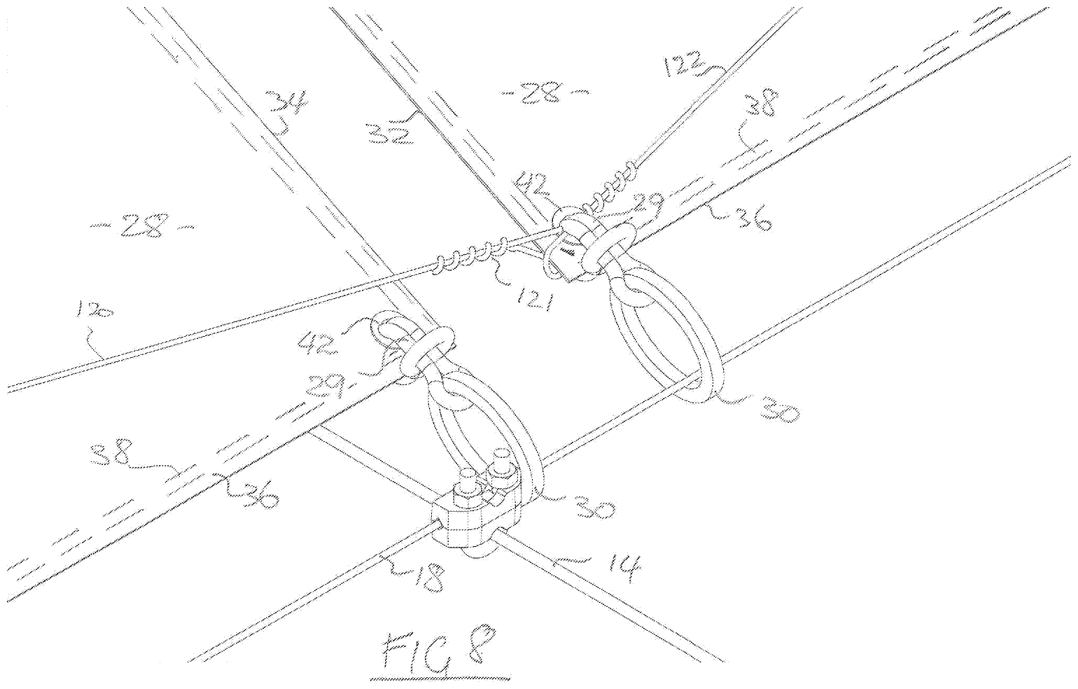

The covering 20 is formed in individual sections 26 arranged in seriatim along the row R to provide a leading section 26a at one end of the row R, a trailing section 26b at the opposite end of the row R and intermediate sections 26c between the leading and trailing sections 26a, 26b. Each section 26 is dimensioned to extend between adjacent support structures 11, i.e. across one bay B, and, as shown in FIGS. 7 to 9, is preferably made from a pair of panels 28. Each of the panels 28 extends from a respective one of the eave guide wires 18 to the ridge guide wire 16. The panels 28 are connected to the guide wires 16, 18 by elastic bands 29 (FIG. 8) and releasable hooks 30. The hooks 30 provide a loose sliding connection on the guide wires 16, 18 and allow relative sliding movement between the panels 28 and the guide wires 16, 18. The hooks 30 are well known in the art, such as those shown in U.S. Pat. No. 5,761,776, the contents of which are incorporated herein by reference, and need not be described further at this time.

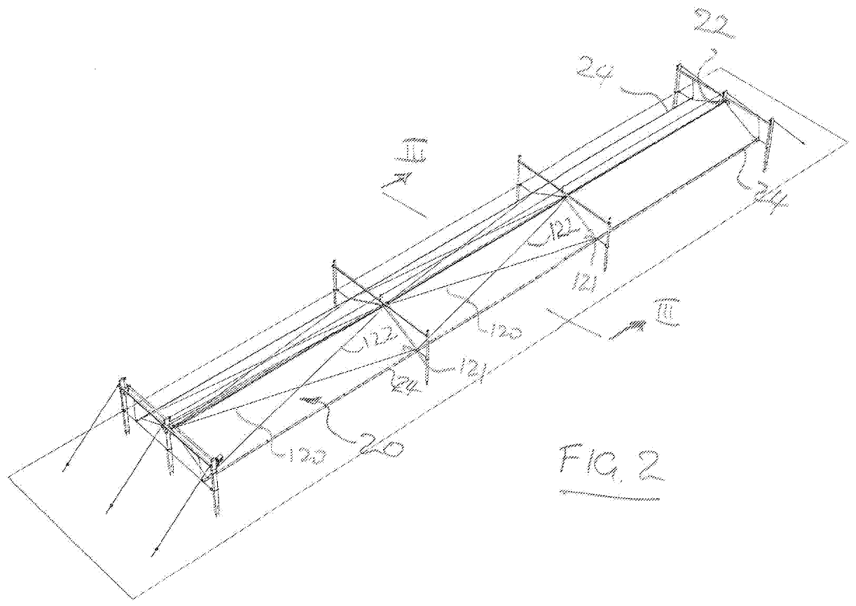

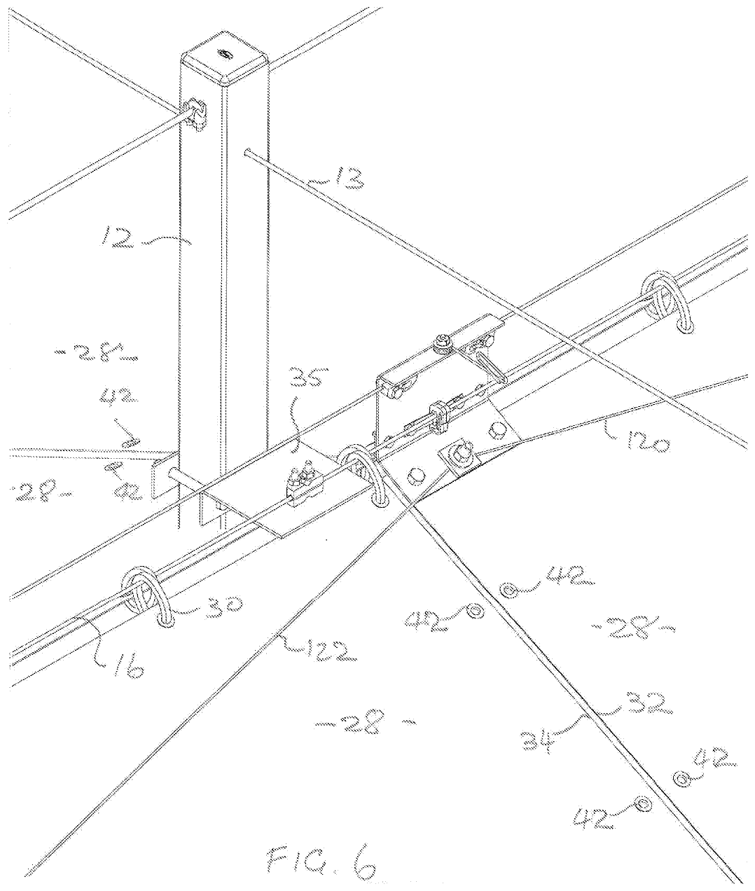

Each of the panels 28 has a leading edge 32 that extends from an upper corner of the panel 28 adjacent the ridge wire 16 to a lower corner of the panel adjacent the eave wire 18. A trailing edge 34 of the panel 26 is secured to a shelf 35 (FIG. 6) secured to the post 12 and to the lateral wire 14 adjacent to the eave guide wire 18 and so is fixed relative to the guidewires 16, 18. The leading edge 32 is free to slide along the guidewires 16, 18 from a retracted or open position as shown in FIG. 1 to an extended or closed position as shown in FIG. 2. Longitudinal edges 36 extend between the leading and trailing edge 32, 34 parallel to the guide wires 16, 18.

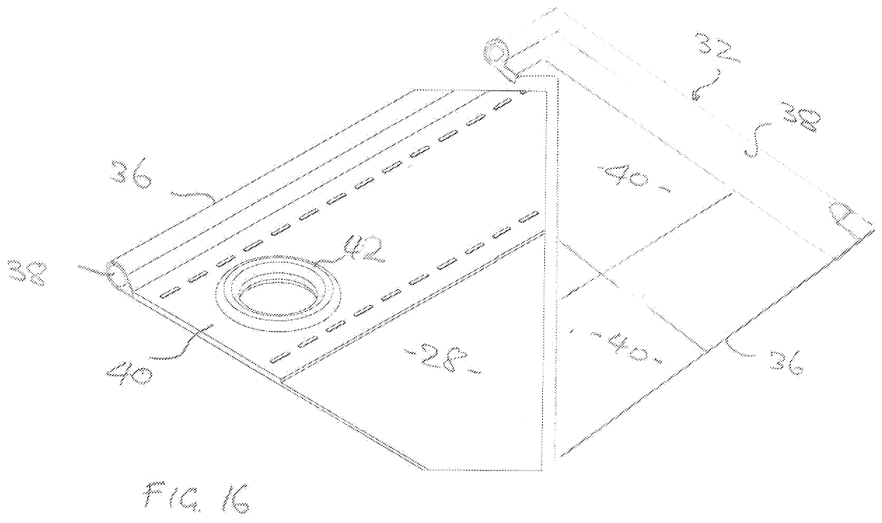

As can best be seen in FIG. 8 and FIG. 16, the edges 32, 34, and the longitudinal edge 36 adjacent to the eave guide wire 18 of the panels 28 are folded over and reinforced by a rope 38 which is heat sealed between the overlapping layers of the panels 28 to form a Keder strip 40. Grommets 42 are installed in the Keder strip 40 to receive the hooks 30 which also pass around the respective one of the wires 16, 18.

The upper longitudinal edge 36 is not reinforced with a rope but has grommets 42 to receive the bands 29 and hooks 30 secure the bands 29 to the ridge wire 16. The upper edge 36 is thus more flexible than the lower edge 36 and pleats more easily in the retracted position. In this manner the motive force required to open or close the cover is reduced whilst the wear resistance at the eaves is maintained.

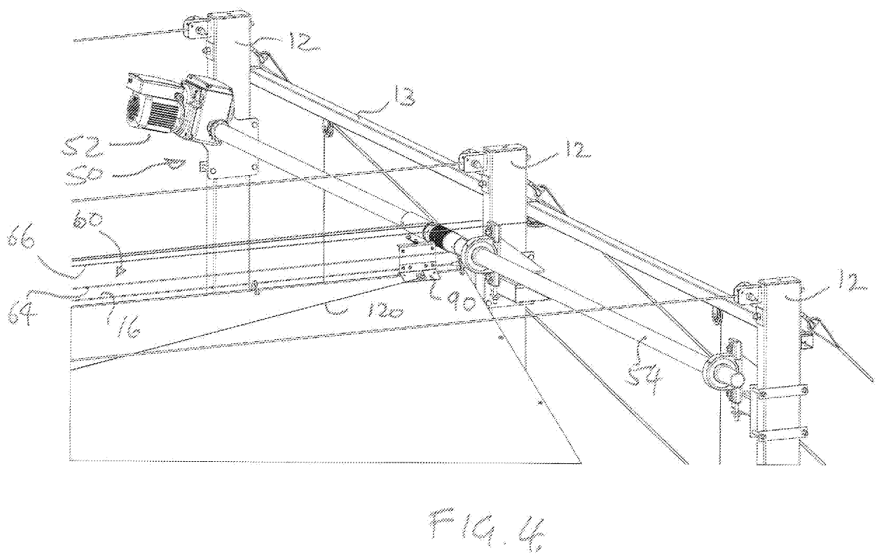

A drive system, collectively indicated by reference numeral 50 and shown in FIG. 4, is mounted to the posts 12 at one end of the row R to move the covering 20. The drive system 50 includes power source, typically an electric motor 52 which drives a horizontal shaft 54. The shaft 54 is supported for rotation by bearings 55 on the post 12 and may extend between multiple rows R so that one motor 52 can move the covering 20 on a number of rows simultaneously. The shaft 54 is located above the peak guide wire 16 at each gable and so may pass between multiple rows R without interfering with the guide wires and cover. Alternatively, an individual motor 52 can be used for each row R or the motor 52 may be portable, such as an electric screwdriver, and can be moved from one row to the other. In some circumstances the motor 52 may be a manually operated chain drive that operates through a reduction gear box to rotate the shaft 54.

A drive cable 60 extends from the shaft 54 to a post 12 at the opposite end of the row R, around a pulley 62 secured to the post 12 and back to the shaft 54. The drive cable 60 provides a driving run 64 and a return run 66 which are generally parallel to but spaced from the ridge guide wire 16. The opposite ends of the drive cable 60 are wound in opposite directions about the shaft 54 so that as the shaft 54 rotates, the driving run 64 and return run 66 move in opposite directions but remain a constant length.

As shown in FIG. 6, the ridge guide wire 16 and drive cable 60 are offset from the posts 12 and the ridge wire 16 is secured to the shelf 35 by a cable clamp 76 with upper and lower jaws 78, 80 bolted to the shelf 35. The ridge guide wire 16 passes between the jaws 70, 80 which are tightened to hold the ridge guide wire 16 to the post 12.

The leading edge 32 of each panel 28 is connected to the driving run 64 by the bracket 90 shown in FIG. 7. The bracket 90 comprises a vertical plate 92 which has a pair of flanges 94 extending outwardly from the lower edge. The flanges 94 diverge at an angle corresponding to the desired profile of the cover 20 and have holes 96 along their length with a spacing corresponding to the spacing of the grommets 42. Fastenings 98, which may be bolts or hooks 30, are used to secure the upper corner at the leading edge of the panel 28 to the flange 94.

The bracket 90 has a pair of cable clamping blocks 100 mounted on the face of the plate 92 with a V-shaped notch 102 to receive the driving run 64 of the cable 60. The blocks 100 clamp the driving run 64 against the plate 92 to fix the bracket 90 securely to the cable 60.

A tab 104 is bolted to the plate 92 to receive the body of a clip 106. The clip 106 is similar to the hooks 30 having a peripheral body 108 and an open centre 110. One side of the body 108 and can be opened to allow the ridge guide wire 16 to pass into the centre 110 and be encompassed by clip 106. The clip 106 is of known construction, such as that shown in U.S. Pat. No. 5,761,776, and need not be described further. The bracket 90 is thus supported on the ridge wire 16 by the clip 106 for sliding movement along the ridge wire 16 and connected to the driving run 64 of the drive cable 62 for movement with it. A wire loop 112 is mounted to the top of the bracket 90 to maintain the return run 66 in proper spaced relationship to the driving run 64.

Operation of the drive system 50 causes rotation of the shaft 54 and moves the driving run 64 relative to the ridge guide wire 16. The bracket 90 associated with each section 26 of the covering 20 moves along the ridge guide wire 16 and pulls each of the leading edges 32 of the panels 28. Each of the panels 28 will thus deploy from a retracted to an extended condition as shown in FIGS. 1 and 2 respectively, and, upon reversal of the motor 52 move in the opposite direction. However, as discussed above, the lower corners of the leading edge 32 which are supported on the eave guide wires 18 may not slide freely and thus inhibit the deployment or retraction of the panels 28.

To mitigate this, a pair of tensile members 120 are attached at a first location adjacent to the bracket 90 of each of the sections 26. The tensile members 120 are conveniently a 2.2 mm polyester monofilament wire that is relatively light, smooth and flexible that will not abrade the panels 28. Alternatively, the tensile members may be rope, cables or wires or even rigid rods if preferred.

The tensile members 120 pass along the outer surface of a respective panel 28 and the opposite end 121 is connected to the leading edge 32 of the adjacent trailing section 26 at a second location. Conveniently, the second location is adjacent to the eave guide wire 18 so the lower corner of each of the panels 28 is connected by a tensile member 120 to the peak of the leading edge of the preceding section 26. As the bracket 90 is moved by the driving run 64, the movement is transferred through each of the tensile members 120 to the lower corner of the following section to pull it along the eave guide wire 18. In this way the friction between the hooks 30 and the eave guide wire at the leading edge is overcome.

To provide for a similar effect when the covering is being moved in the opposite direction, i.e. to the retracted position in the example above, a second pair of tensile members 122 are connected from the bracket 90 of the trailing section to the lower corners of the leading edge 32 of the preceding section 28.

Thus movement of the bracket 90 of one section 26 in either direction by the driving run 64 of cable 62 is transferred through the tensile members 120, 122 to the lower corners at the panels 28 of another section 26 to promote sliding of the panels on the eave wires 18.

The leading edge 32 of the leading section 26a, that is the section closest to the drive shaft 54, cannot be connected to a preceding section. To assist in moving the leading section along the eave guide wires 18, an additional tensile member 124 is connected to each lower corner of the leading edges 32 of section 26a as shown most clearly in FIGS. 9. 10 and 15. To effect a direction reversal, the additional tensile member 124 passes forwardly to a pulley 126 on the transverse wire 14 and upwardly to pulleys 128, 130 located on the cross member 13, The pulley 130 directs the tensile member 124 over the drive shaft 54 and rearwardly. The opposite end 125 of the tensile member 124 is connected to the return run 66 of the drive cable 62.

With the drive system 50 operating to move the covering 20 from a retracted condition of FIG. 1 to the deployed condition of FIG. 2, the driving run 64 will cause the bracket 90 of the leading section 26a to move toward the drive shaft 54. At the same time, the return run 66 will move away from the drive shaft 54, i.e. in the opposite direction to the bracket 90. The movement will be transferred through the additional tensile members 124 and pull the leading edge 32 of the leading section 26a along the guide wire 18. When the movement is reversed, the tensile members 122 from the adjacent intermediate section 26c act on the lower corners of the leading edge of the section 26a to pull it to a retracted position.

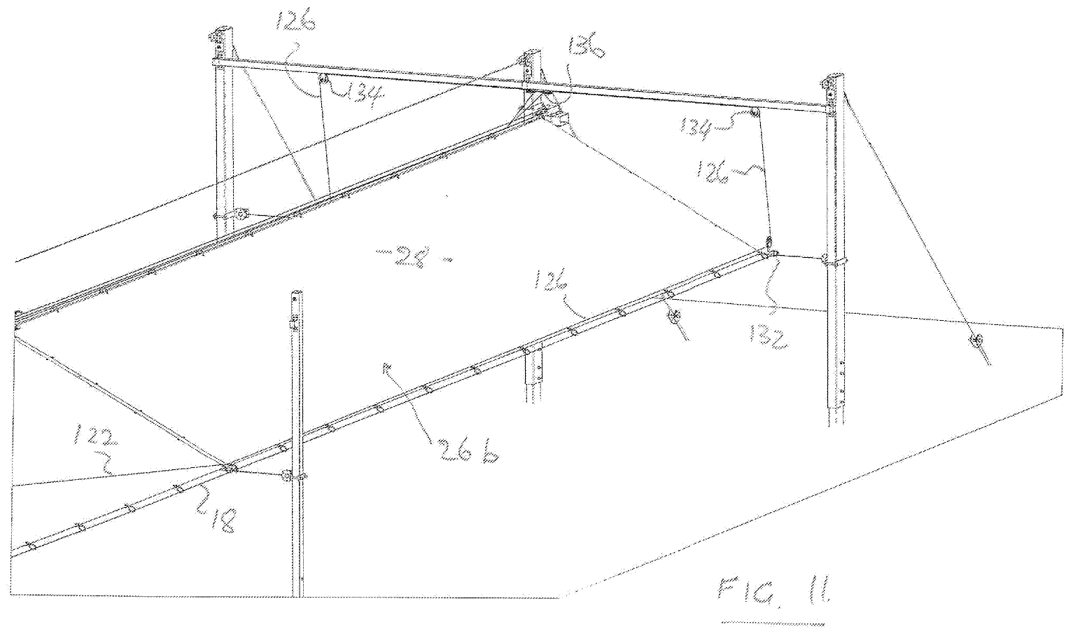

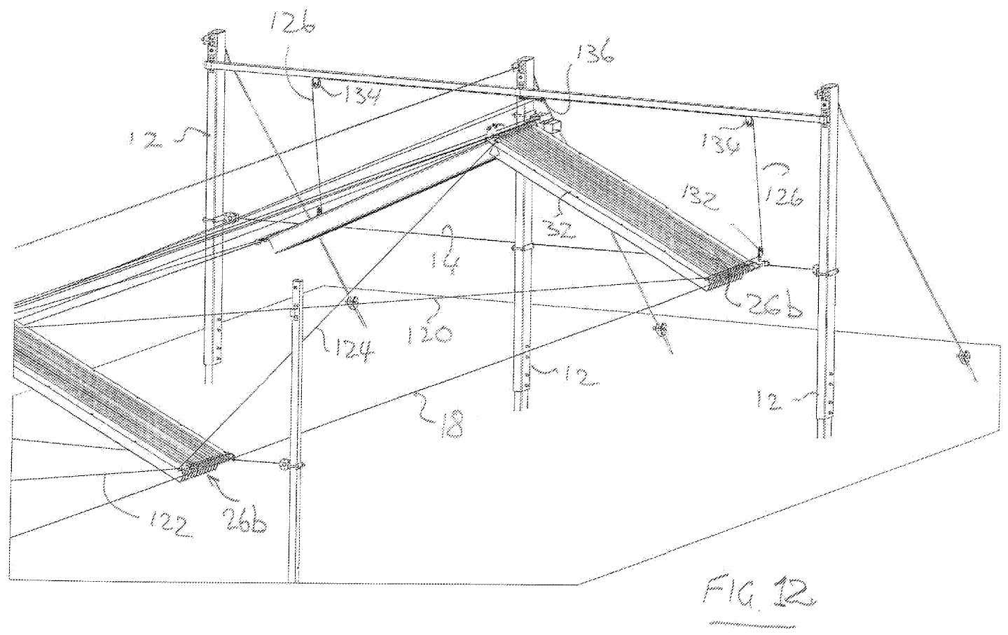

A similar arrangement is provided at the trailing section 26b as shown in FIGS. 11 and 12. Further tensile members 126 are connected to the lower corners of the leading edge 32 of the trailing section 26c and pass rearwardly through pulley 132 on the wire 14 and upwardly through pulleys 134, 136 on cross member 13 to be connected to the return run 66. In this case, the tensile members 122 from the adjacent intermediate section 26c pull the leading edge to the deployed condition with the rearward movement of the return run 66 permitting the further tensile members 126 to follow the movement. When the covering 20 is retracted, the forward movement of the return run 66 acts through the tensile members 126 to pull the leading edge 32 of the trailing section 26b rearwardly to the retracted position.

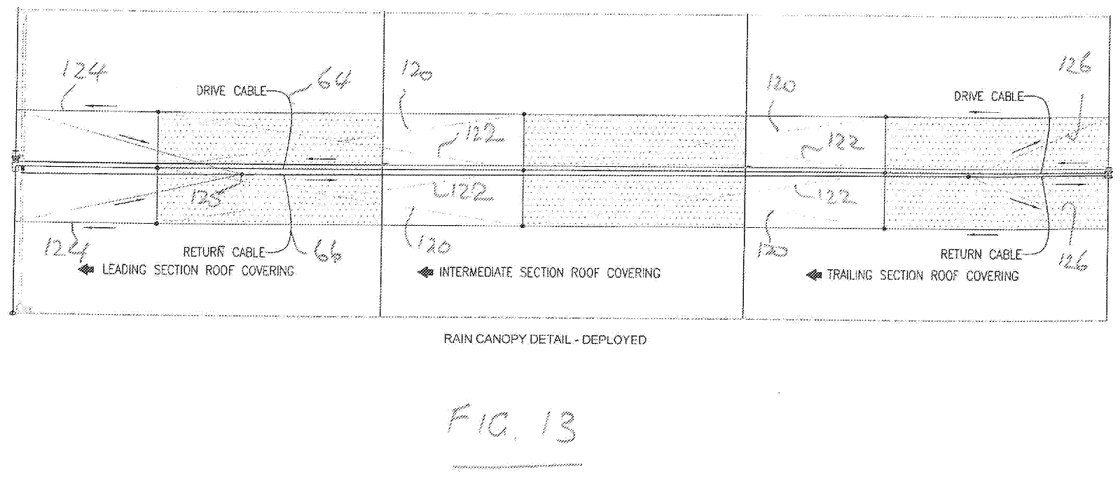

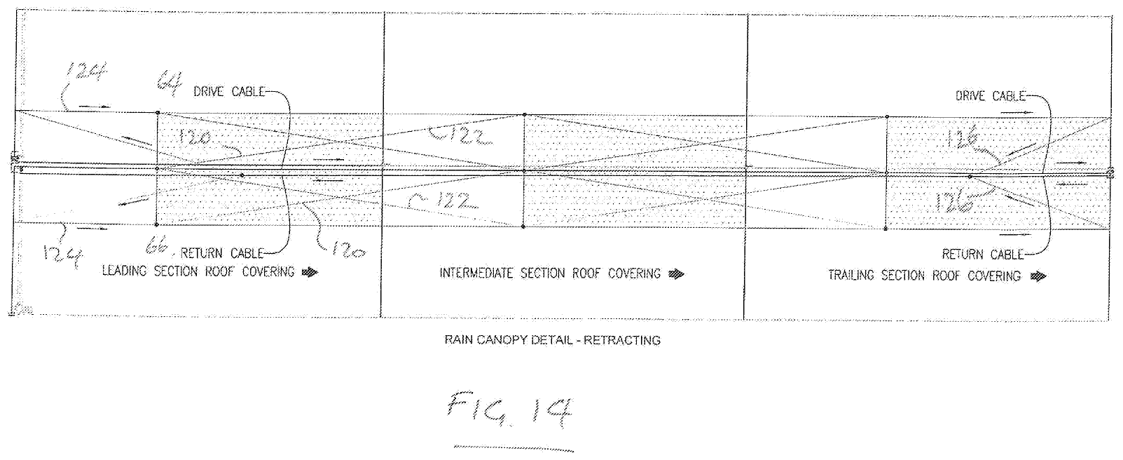

The organisation and direction of movement of the tensile members 120, 122, 124 and 126 is shown in FIGS. 13 and 14 for movement from retracted to deployed (FIG. 13) and from deployed to retracted (FIG. 14). It will be seen that the connection of the tensile members 124, 126 to the return run via the direction reversing pulleys provides control over the leading edge of the leading section 26a and the trailing section 26b in both directions.

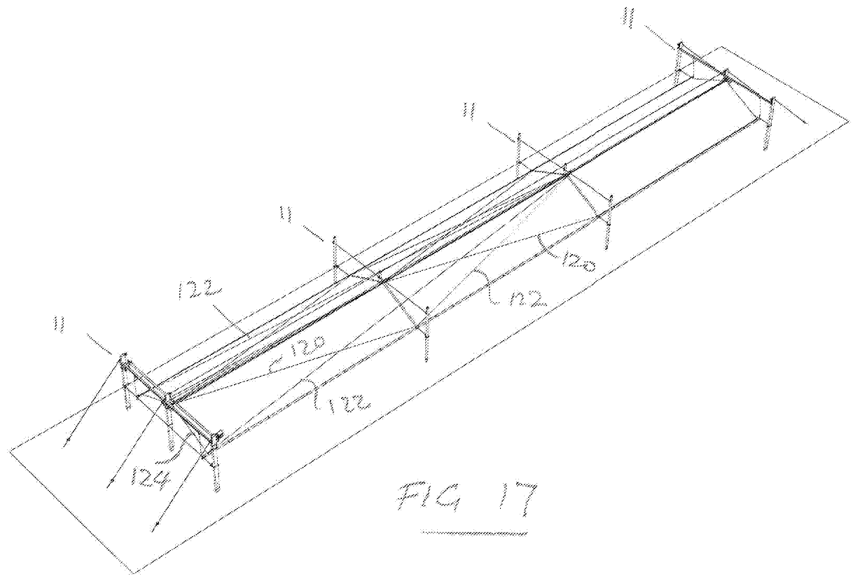

In some circumstances, depending primarily on the dimensions of the sections 26, it is found that the connection of the tensile member 124 and the tensile member 122 at the leading edge 32 places a significant lateral load on the eave guide wire 18. This may be sufficient to displace the wire 18 and distort the balance of the covering. An alternative arrangement to address this is shown in FIG. 17 where like reference numerals are used. The tensile member 122 extends from the lower corner of the leading edge 32 of the leading section 26a to the bracket 90 of the next but one section, in this case the trailing section 26b. Where multiple intermediate sections 26c are used then the connection would be to one of those. The effect of this is to increase the included angle between the tensile members 122 and 124 and thereby reduce the lateral forces acting on the lower corner of the panel 28.

It will be seen therefore that the provision of the tensile members from the peak of one section to the eaves of the adjacent section can be used to assist movement of the panels along the eave guide wires and promote a smooth sliding action for the panels. The arrangement is achieved with a single power source and avoids a complex jointed drive shaft.

It will be apparent that different profiles of covering may be utilised. For example, a shed roof may be provided with a single inclined panel in each section. In this arrangement a single tensile member from one location on one of the sections, typically the higher point of the leading edge, to a second location on the adjacent panel, typically the lower point of the leading edge, may be used to maintain proper sliding motion.

The attachment of the tensile members to the peak at one end and the eave at the lower end may also be chosen to suit individual needs. The attachment to the driven run may be at the connection of the section to the run or may be spaced from it along the leading edge provided there is sufficient stiffness in the leading edge to transmit the movement. Similarly, the connection may be made at a location spaced from the leading edge in the direction of the ridge wire.

The attachment to the adjacent panel may also be varied from the location of the eaves cable but it is believed the optimum locations are at the peak and at the eaves where there is adequate structure to withstand the loads imposed.

The points of attachment should be chosen so as to convey the movement of the leading edge by the driven run through the tensile member to another of the panels so as to induce movement of the leading edge along the eave wires 16. The exact location will depend on the nature of the connections of the panels to the guide wires and driving cable, the dimensions of the panels and the durability of the panels.

As described, the driven run is attached to the peak but it might also be attached to the eaves with the tensile members extending to the peak on the adjacent section. This would of course require a drive cable at both eaves and might impair access to the crop.

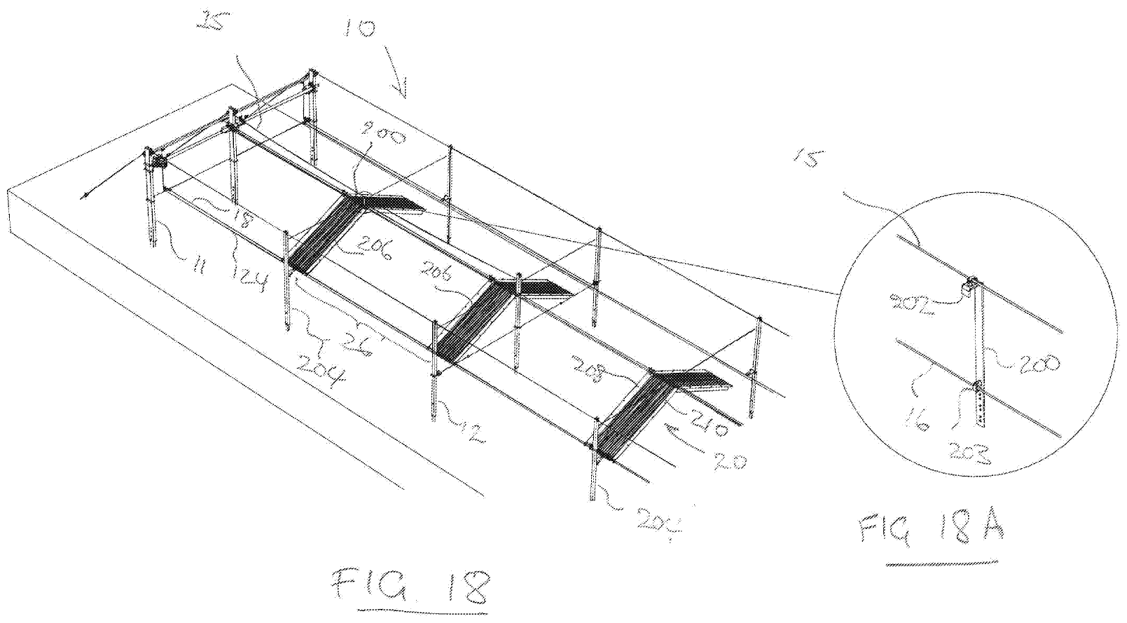

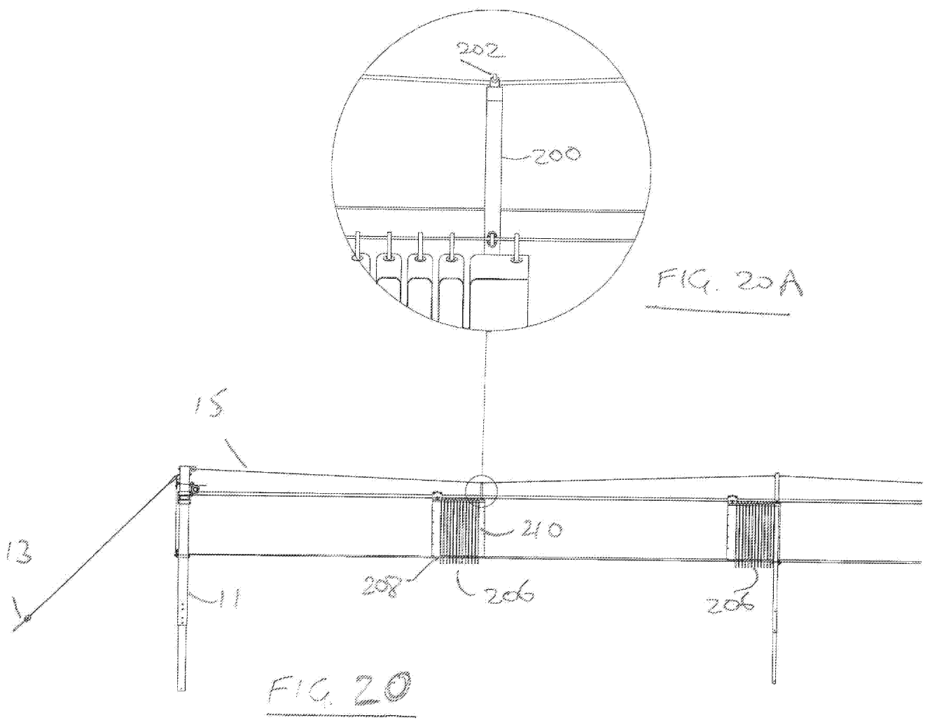

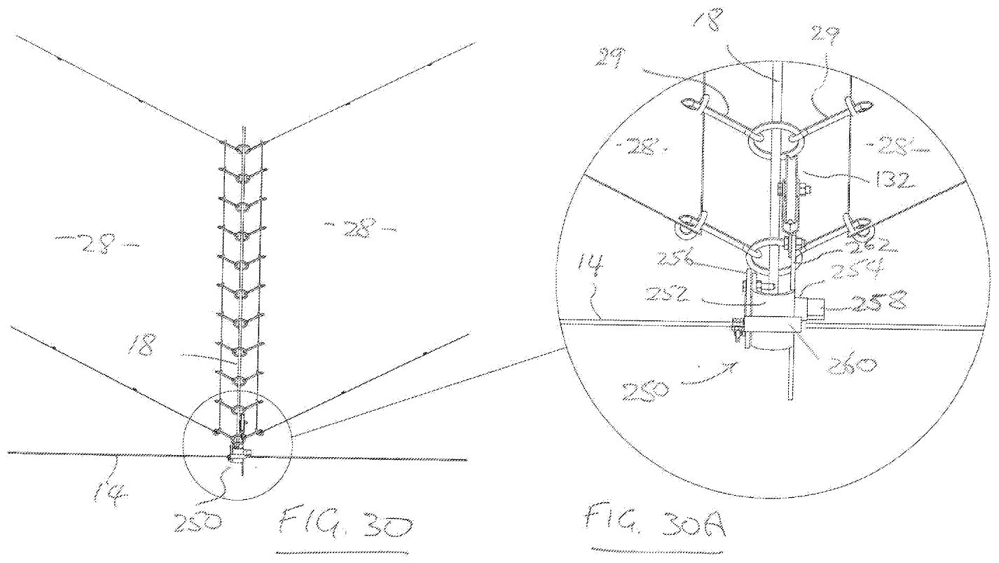

A further embodiment of a retractable roof structure is shown in FIGS. 18 to 30 where like reference numerals will be used to describe like components. The variability of tension in the roof covering 20 may cause flapping of the covering if the tension is reduced significantly, which in turn may lead to a reduced life for the covering. Alternatively, if the tension is too great, the sliding of the hooks is inhibited and extra loads are applied to the drive system 50.

These issues are mitigated in the embodiment shown in FIG. 18. The roof structure 10 includes longitudinally spaced supports 11 with a stabiliser wire 15 connected to each of the central posts 12. A hanger 200, shown in greater detail in FIG. 18A is located midway between the posts 12 and extends between the stabiliser wire 15 and the ridge wire 16. The hanger 200 has a U-bolt 202 at its upper end to engage the stabiliser wire 15 and an adjustable U-bolt 203 at its lower end. The bolt 203 may be adjusted to different positions on the hanger 200 to transfer load between the wires 15, 16 and inhibit vertical separation of the wires 15, 16. The hanger 200 is secured to each of the wire 15, 16 by the bolts 202, 203 to inhibit longitudinal movement of the hanger 200.

Additional support for the stabiliser wire 15 is provided by intermediate posts 204 with lateral wires 206 extending between the posts 204.

The covering 20 is divided into sections 26 between each of the support structures 11 but in this embodiment, in view of the connection of the hanger 200 to the ridge wire 16, each section 26 is divided in to two subsections 206. The peak of each subsection 206 is slidably supported on the ridge wire 16 and the eaves are slidably supported on the eave guide wires 18.

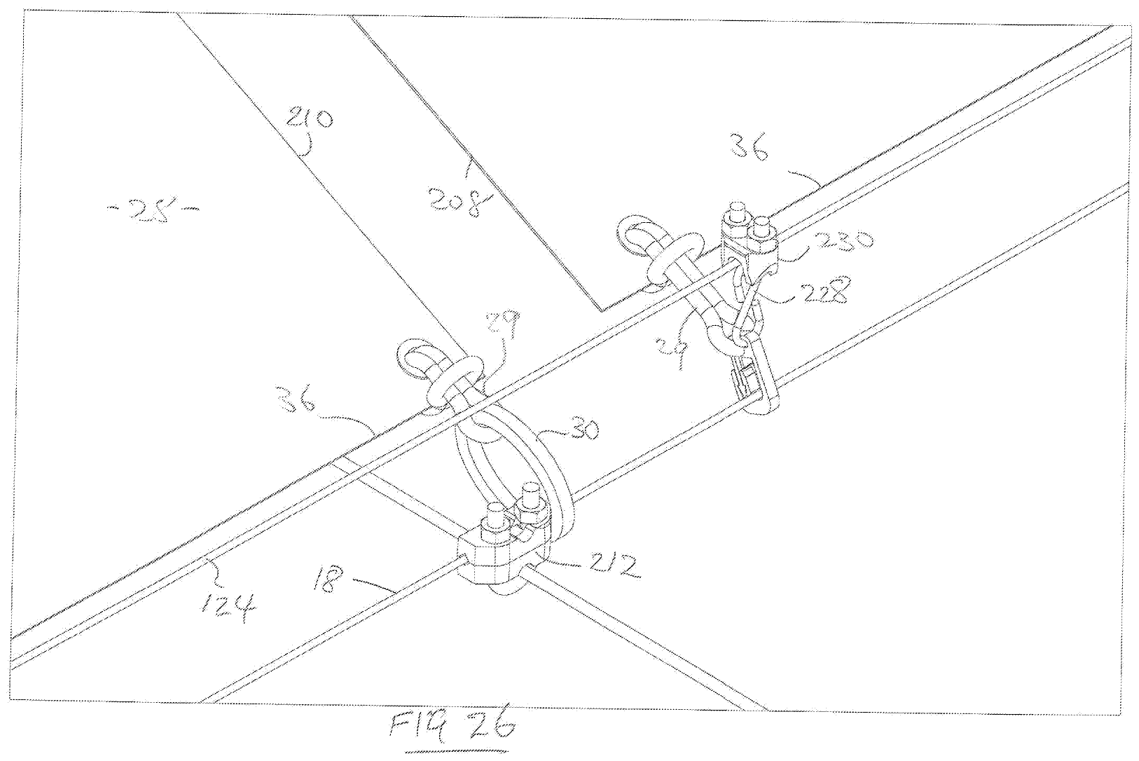

Each subsection 206 has a leading edge 208 and a trailing edge 210. The leading edge 208 is free to move between a retracted and deployed position by sliding on hooks along the ridge wire 16 and eave guide wire 18 as discussed above. Movement of the trailing edge 210 is prevented at the peak by abutment with the hanger 200 in midspan or the post 12 at one end of the section 26. Similarly, each of the trailing edges 210 is secured to the eave guide wire 18 by an abutment of the ring 30 with clamp 212 as shown in FIG. 26. The hanger 200 provides additional support for the ridge wire 16 from the stabiliser wire 15 without reducing the spacing between the support structures 11.

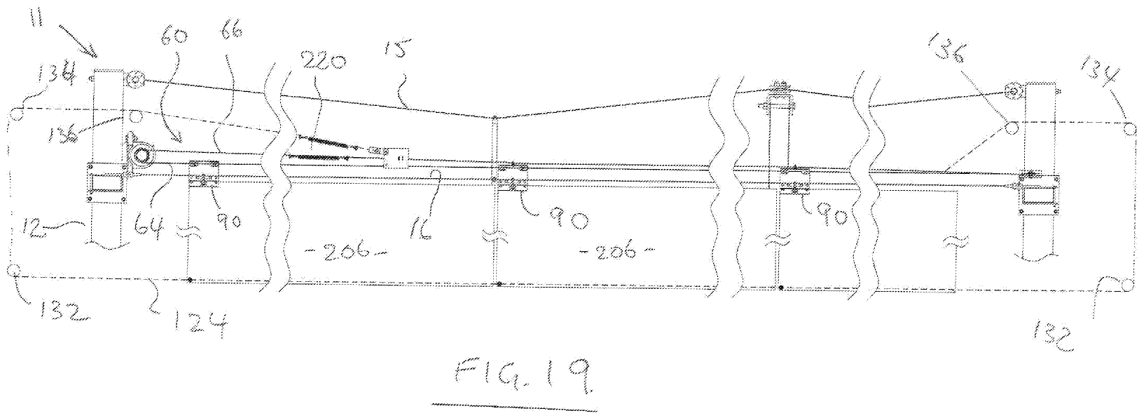

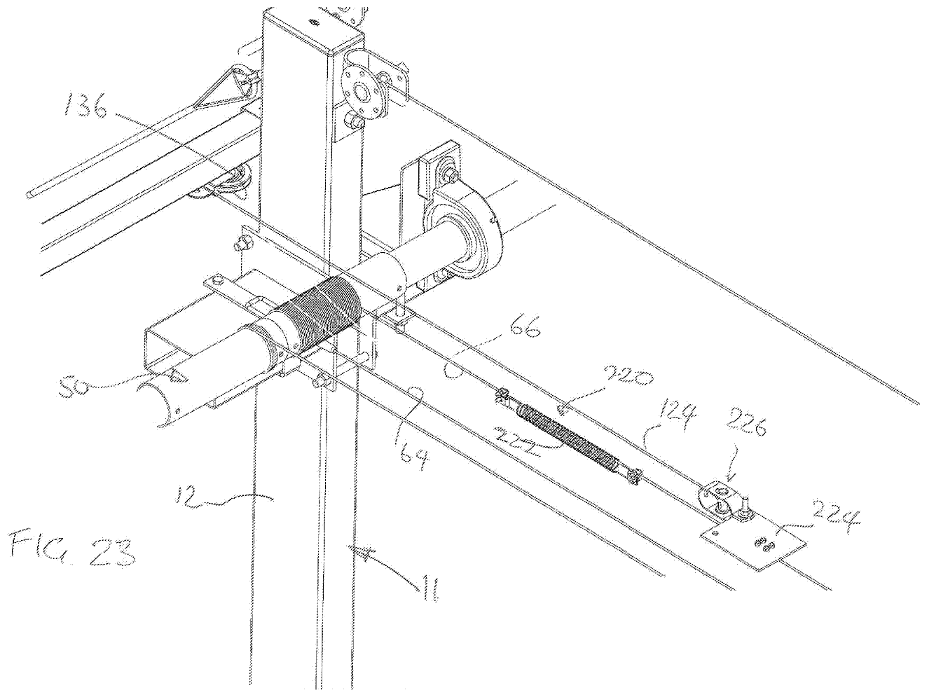

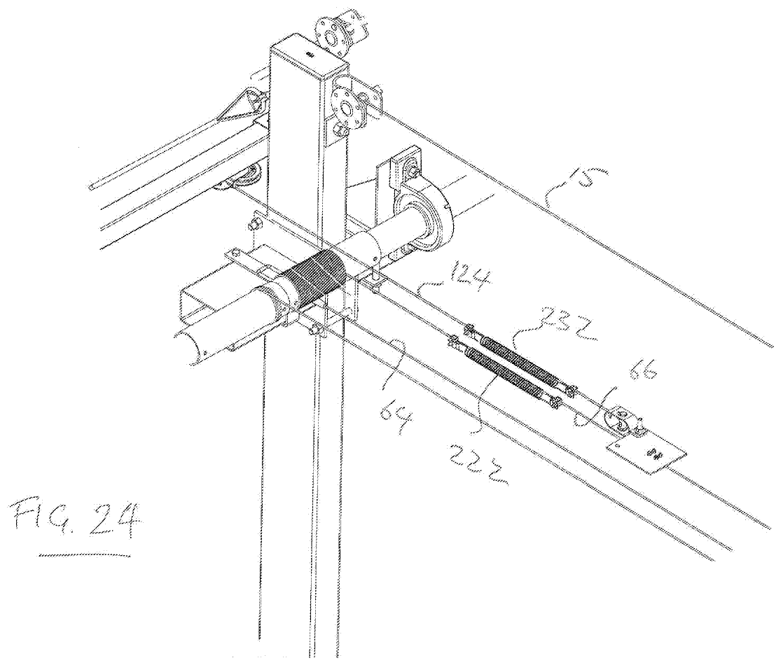

As can be seen in FIG. 19 the peak of the leading edge 208 of each subsection 206 is secured to the driving run 64 of the drive cable 60 by a plate 90, similar to that shown in FIG. 7 so that the subsections 206 may be moved between retracted and deployed positions in unison. To maintain tension in the drive cable 60 as the direction of drive is reversed, a spring tensioner assembly 220 is incorporated into the return run 66. The spring tensioner assembly 220 is shown in greater detail in FIG. 23 with an alternative embodiment shown in FIG. 24. Referring to FIG. 23, an extension spring 222 is clamped to the return run in an extended state so that it applies a tension to the cable. Any slackness in the drive cable 60, such as can occur when the direction of movement is reversed, causes the spring to contract and restore the tension.

A plate 224 is connected to the return run 66 and carries a cable capstan 226 mounted at one corner. A tensile member which could be wire or cable, referred to as a diverter wire, 124, is connected to the capstan and passes forwardly through pullies 136, 134, 132 (FIG. 19) to the leading eave of the first subsection 206. The wire 124 passes along the eaves of the covering and is secured to the leading edge 208 of each panel 28 by an S-clip 228 and clamp 230 (FIG. 26). Each of the leading edges 208 is therefore secured at the eave to the diverter wire 124.

The diverter wire 124 continues to the distal support structure 11 where it is routed through the pullies 132, 134, 136 and connected to the return run 66 in the distal subsection 206.

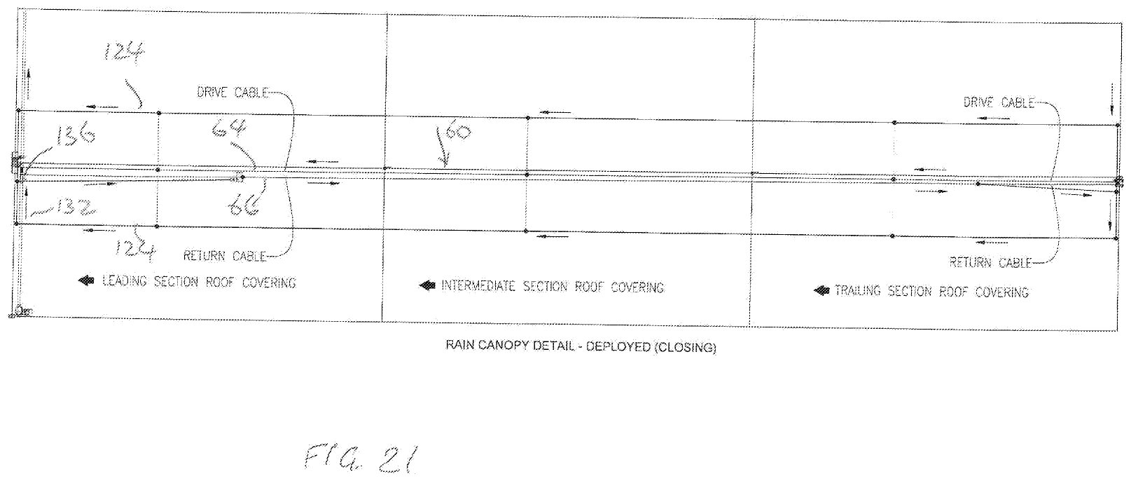

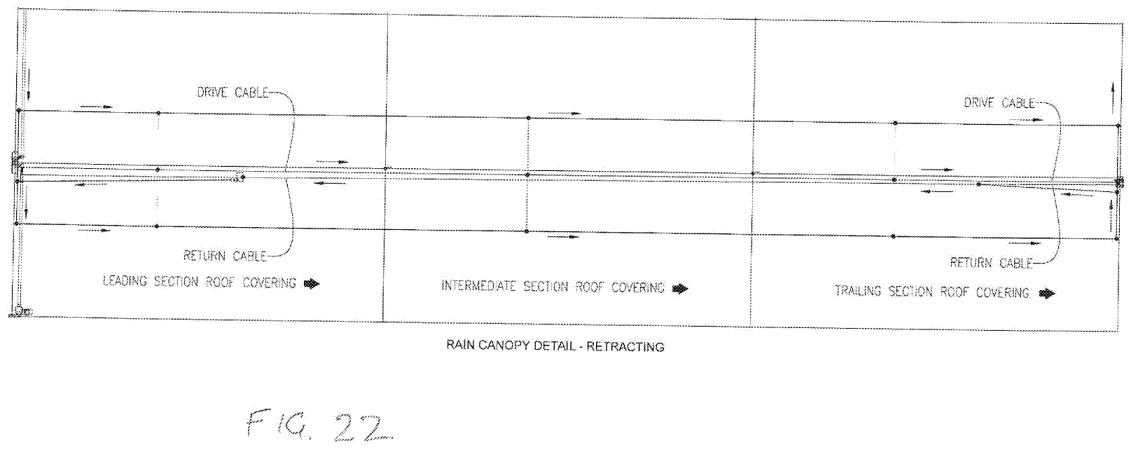

A similar diverter wire 124 is routed along the opposite eave and connected to each of the leading edges 208, as indicated in FIGS. 21 and 22 so that both eaves are moved in unison by respective diverter cables.

Where necessary, a second tensioning spring 232 is incorporated into the diverter wire 124 as shown in FIG. 24 to maintain tension in the diverter wires 124.

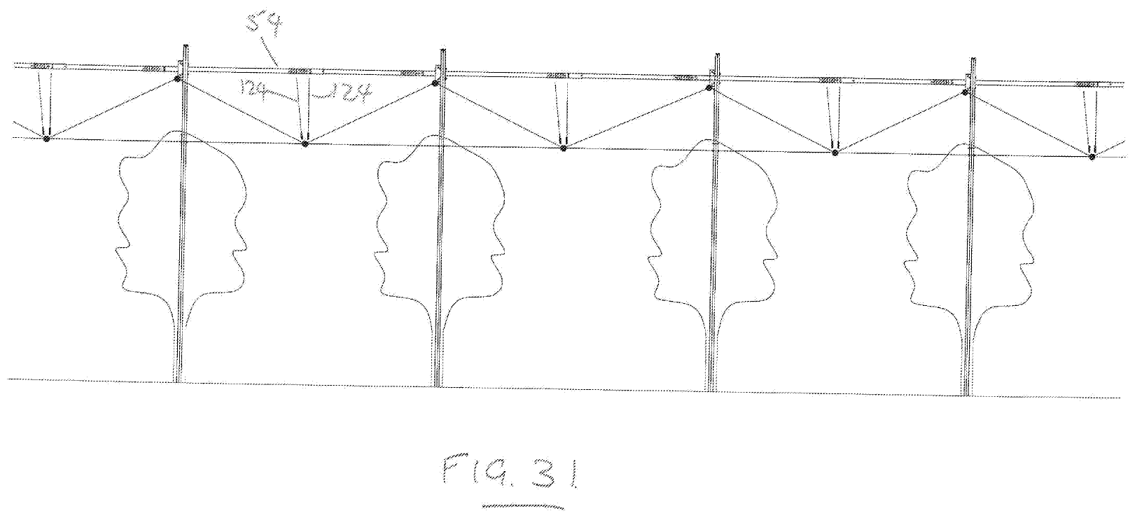

The pulley 132 is supported on a lateral wire and therefore subject to changes in orientation as the tension in the diverter wire 124 varies. To alleviate this, the pulley 132 is incorporated into the connection of the eave guide wire 18 as shown in FIG. 30. A wire tensioner 250 has a U-shaped body 252 which supports a spindle 254. A locking disc 256 is mounted on one end of the spindle 254 and a square drive boss 258 provided at the opposite end of the spindle 254.

The body 252 has a sleeve 260 that receives the lateral wire 14. The eave guide wire 18 is wrapped around the spindle 254 and torque applied through the boss 254 to impart a significant tension in the guide wire 18. The locking plate 256 is then pinned to the body 252 to maintain the tension. Alternatively, the body 252 could be clamped onto the lateral wire 14

The body 252 has an ear 262 extending above the guide wire 18 with pulley 132 mounted on the ear. The pulley is aligned with the guide wire and forces in the diverter wire 124 are resisted by the tension in the guide wire and lateral wire 14 to reduce deviation in the pully 132. The pulley 132 can be aligned with the eave guide wire 18 by installing washers between the pulley and the ear.

In operation, to move the cover from a retracted to a deployed position as shown in FIG. 21, the drive system 50 is operated to rotate the drive shaft 54 and pull the driven run 64 of the drive cable 60 toward the support 11. The driven run 64 moves the peak of leading edge 208 of the first sub section 206 along the ridge wire 16 toward the support 11 and so closes the cover. The peak of each of the successive subsections 206 is similarly moved along the ridge wire to close each subsection.

The return run 66 of drive cable 60 is moving in the opposite direction and transmits that movement through the pullies 132, 134, 136 to the leading edges 208 of the subsection 206 at the eaves. Because of the direction reversal through the pullies, the eaves are also pulled toward the support 11 so that the peak and eaves move conjointly to the closed position.

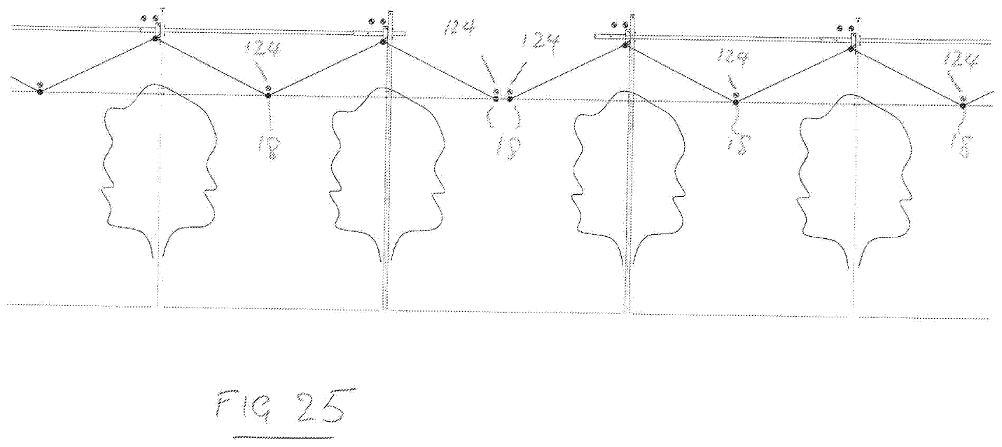

To open the covering 20, the shaft 54 is reversed (FIG. 22) so the driven cable pulls the peak away from the support 11 and causes a corresponding movement of the diverter wire 124 along the eaves. The covering 20 is thus retracted.

Where the roof structure extends over multiple rows of trees as illustrated in FIG. 25 a single eave guide wire 18 and diverter wire 124 may be used in each valley. The adjacent lower edges of each panel 28 are connected by elastic bands 29 to the common eave guide wire 18 so they can slide in unison along the eave guide wire 18 and the connection to the diverter wire 124 is duplicated so movement of the diverter wire 124 will act to move adjacent leading edges at the eave. It will also be noted that a common drive 50 can be used with multiple rows R using a single linear shaft 54 to power drive cable of each row R. The shaft is supported on the structures 11 at a common height and so avoids a complex jointed arrangement.

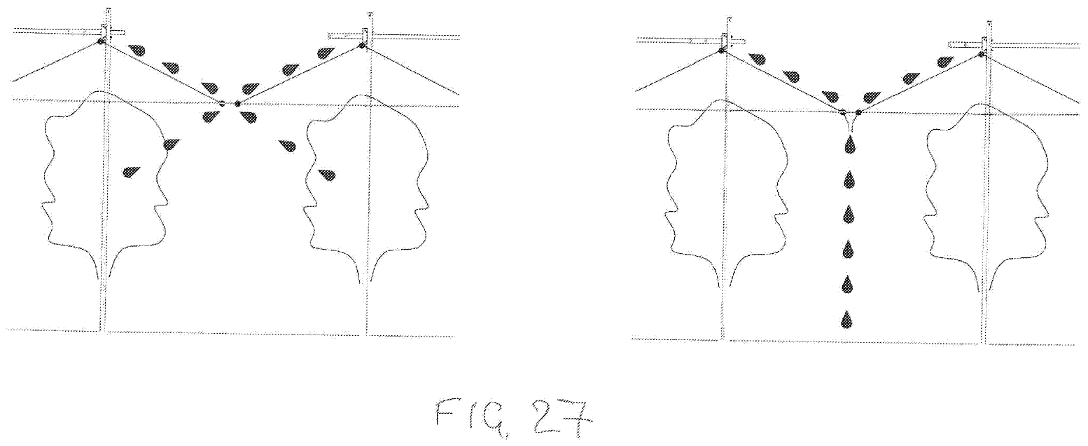

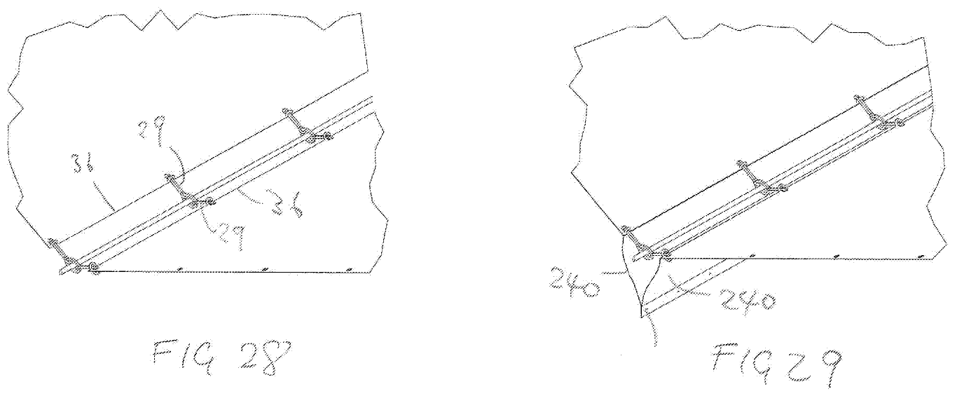

The elastic bands 29 used to connect the panels to the eave guide wire 18 provide a degree of resilience to accommodate wind loads and fluctuating tensions caused by the movement along the wires but also introduce a spacing of the lower edges 36 between adjacent rows. In some circumstances this can lead to an ingress of rainwater as shown in FIGS. 27 and 28 and also an egress of heat. To alleviate these effects, a flap 240 is provided along the lower edge of the panels. The flaps 240 are connected to one another periodically, for example by staples, snap fasteners, hook and barb fastening or the like to form a gutter. The spacing between the fastenings allows water to escape and fall to the ground between the row without damaging the crop. As the panels 28 of adjacent subsections move in unison the periodic fastening allows folding of the panels 28 without interfering with the operation.

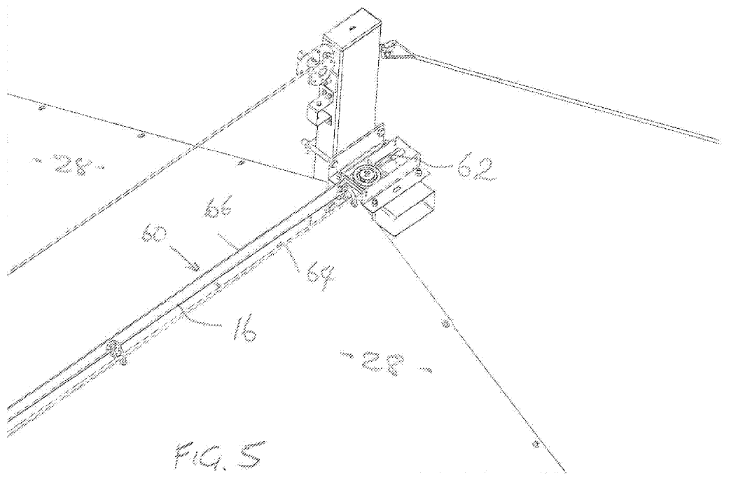

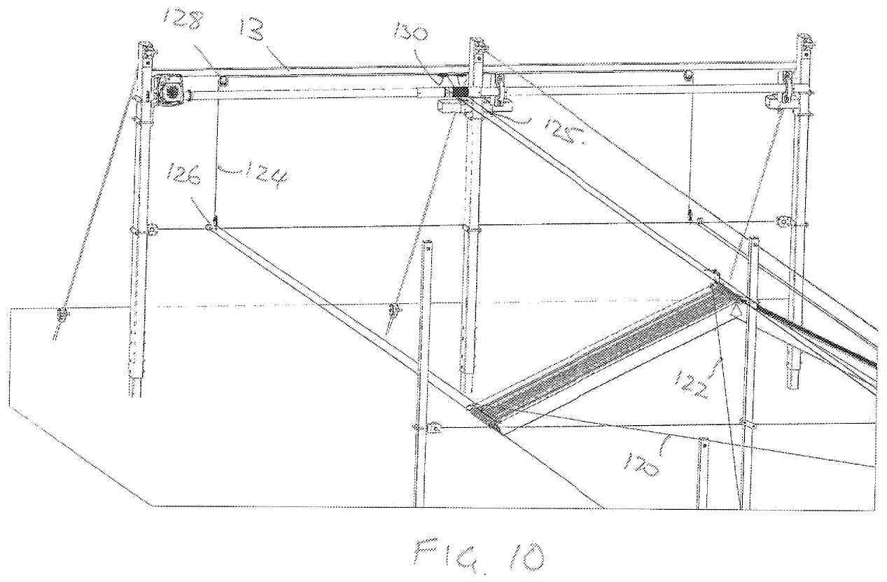

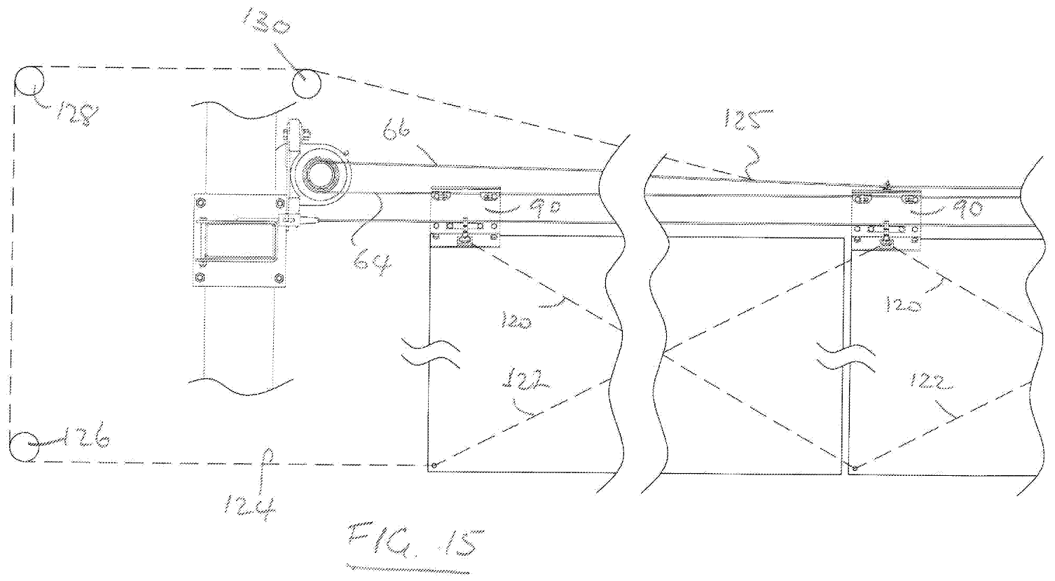

In the embodiment of FIG. 18-30, the diverter wire 124 is used to move the first and last leading edges as described in the embodiment of FIGS. 1 to 17 and also to move the intermediate leading edges to avoid the use of the tensile members 120, 122.

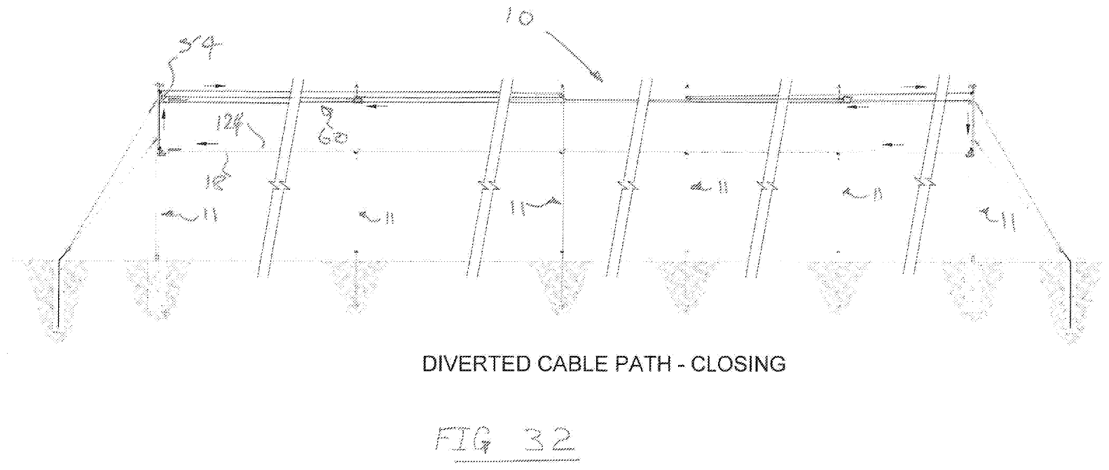

A further embodiment is shown in FIG. 31 in which the diverter wires 124 are directly connected to the shaft 54. The diverter wires are wound in the opposite direction to the driven run 64 to produce a reversal of direction and avoid the connection to the driven run of the drive cable 60. However, the wrapping on the shaft 50 in this manner introduces misalignment causing wear and fraying of the cable so that the embodiment of FIG. 18 is preferred in most applications.

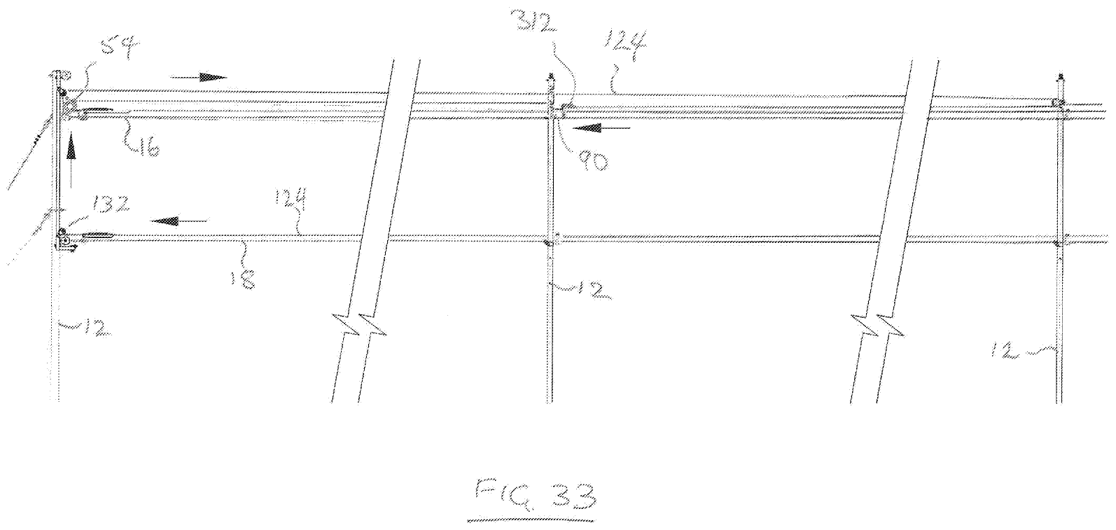

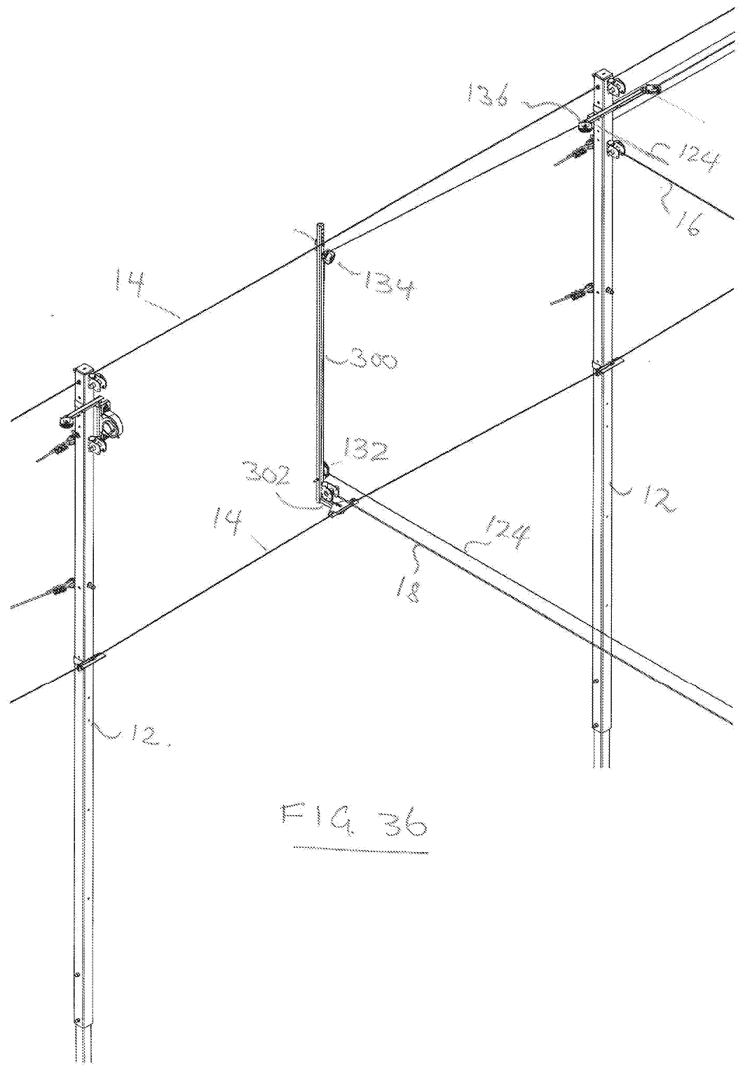

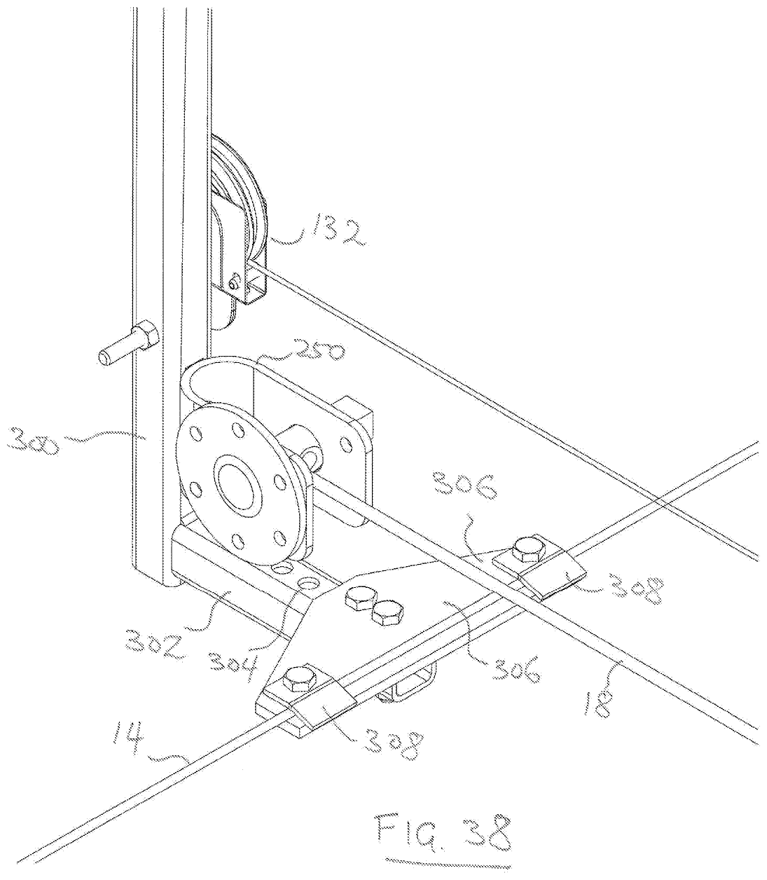

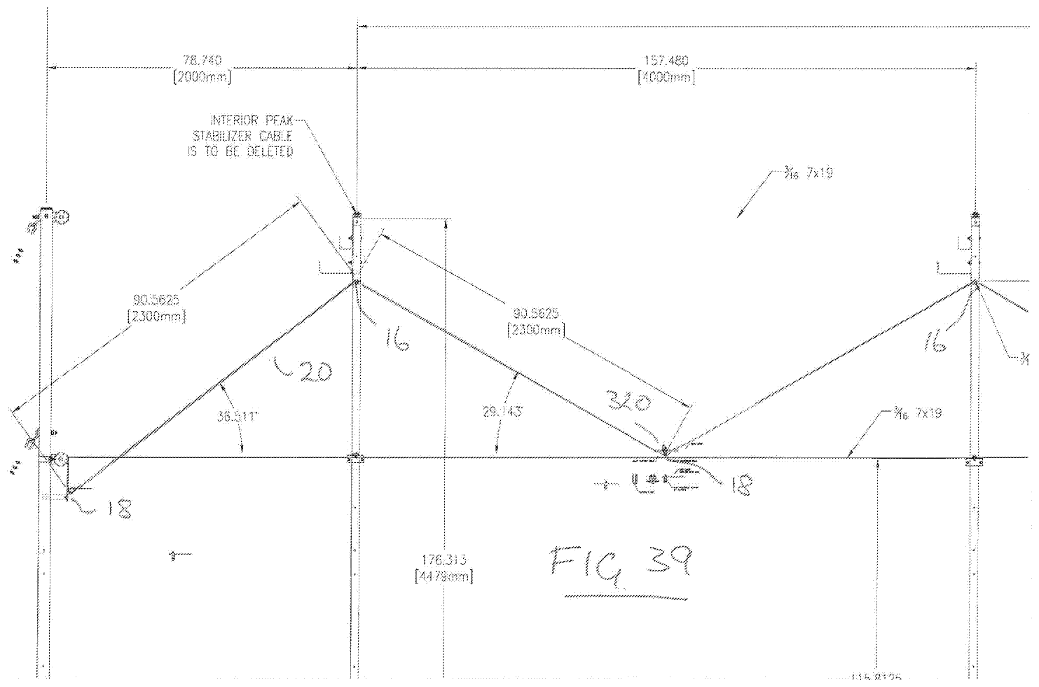

A yet further embodiment, similar to that of FIGS. 18 to 30, is shown in FIGS. 32 to 41 with like reference numerals denoting like components. As in previous embodiments and as shown generally in FIG. 32, the roof structure 10 is arranged as a series of bays B over a row R with each bay delimited by a pair of support structures 11. The support structures 11 are uniformly spaced between a leading structure 11 at the leading end and the structure 11 at the distal end of the row R.

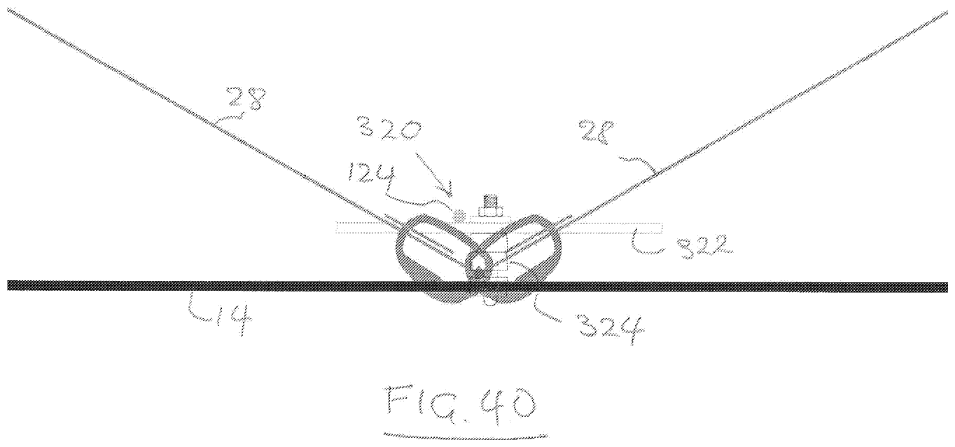

As can be seen in FIG. 39, the retractable roof is arranged as a ridged profile with the covering 20 supported on a ridge wire 16 and laterally spaced eave wires 18. A common drive shaft 54 (FIGS. 32, 33, and 35) is supported on the structure 11 at the end of each row above the ridge wire 16 and where multiple rows are to be covered the shaft 54 extends between the support structures 11 at one end of each row R in the manner shown in FIG. 25.

A drive cable 60 extends as an endless loop between the central posts 12 at the opposite ends of the row R with a driven run 64 and a return run 66. The leading edge of each panel 28 is connected to the driven run 64 by a plate 90, as described above with respect to FIGS. 7 and 19, so the peak of each panel 28 is moved along the ridge guide wire 16 by the movement of the driven run 64.

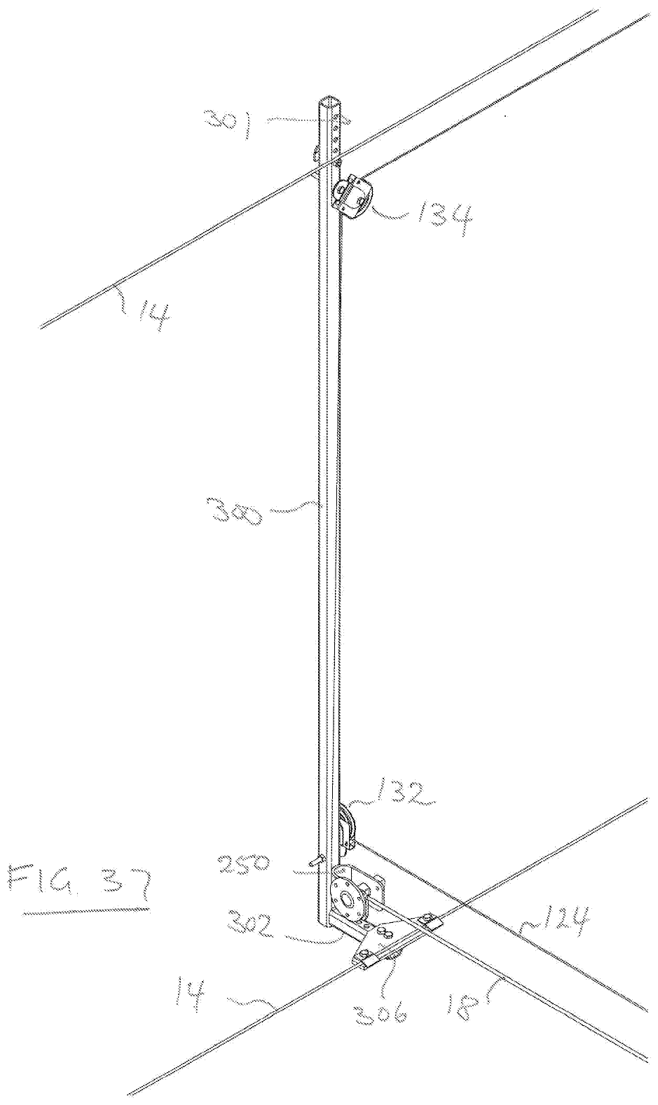

As described above with respect to the embodiment of FIG. 18, the leading edges of each of the panels 28 are connected to a diverter wire 124 adjacent the eave support wire 18 which is entrained at one end about pullies 132, 134, 136 and derives its movement from operation of the drive cable 60 as will be described more fully below. Referring to FIGS. 36-38, the pulleys 132, 134 are mounted on a rigid support provided by a vertical tube 300 which extends between the upper and lower horizontal wires 14. The upper wire 14 is clamped to the tube 300 by a U-bolt or similar clamp using one or more of an array of adjustment holes 301. A foot 302 projects from the lower end of the tube 300 and has adjustment holes 304 equally spaced along its upper and lower faces. A cross beam 306 is bolted to the foot 302 using the holes 304 and has a pair of cable clamps 308 on its upper surface that retain the lower wire 14.

The vertical tube 300 and the foot 302 are connected to upper and lower cables 14 instead of a rigid member since orchards are not always built on flat land and existing orchards do not always have a consistent spacing between tree rows which means that supports 12 may be at a variable spacing. Using cables 14 instead of a rigid member allows for the house to follow rolling grades and for supports 12 to be a variable spacings without any customization.

The tensioner 250 for the eave wire 18 is welded or otherwise secured to the front face of the tube 300 with the pulley 132 mounted on its side face immediately above and the pulley 134 mounted on the front face adjacent the upper wire 14.

The tube 300 maintains the spacing between the pullies 132, 134 as tension is applied to the diverter wire 124. The connection to the wires 14 also maintains the lateral spacing between adjacent eave wires 18. The tension applied through tensioner 250 will cause bowing of the lower wire 14 and the holes 304 allow adjustment of the cross beam on the foot 302 to maintain the tube 300 substantially vertical, thereby maintaining the required geometry of the diverter wire 124.

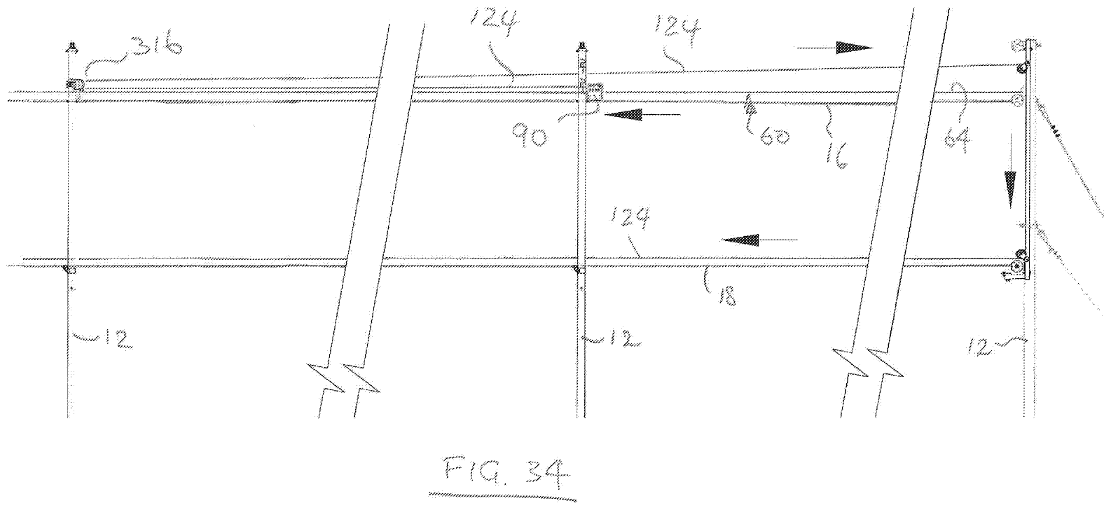

As can best be seen in FIGS. 33, 35 and 36, the diverter wire 124 passes through the pulley 136 and extends parallel to the ridge wire 16 away from the end support 11. The diverter wire 124 passes around a direction reversing pulley 310 that is mounted to the centre post 12 of the support at the end of the second bay B so that it extends back toward the end support 11. The diverter wire 124 is connected to the driven run 64 by a clevis or tightener 312 hat is pivotally connected to the plate 90 that connects the leading edge of the second panel 28 to the driven run 64. The plate 90 is secured to the driven run 64 by clamps 314 and is free to slide on the ridge guide wire 16. The plates 90 are spaced apart by the length of one bay so that when the leading edge of panel 28 abuts the end support structure 11, the clevis 312 is adjacent the support structure 11 between the first and second bays B.

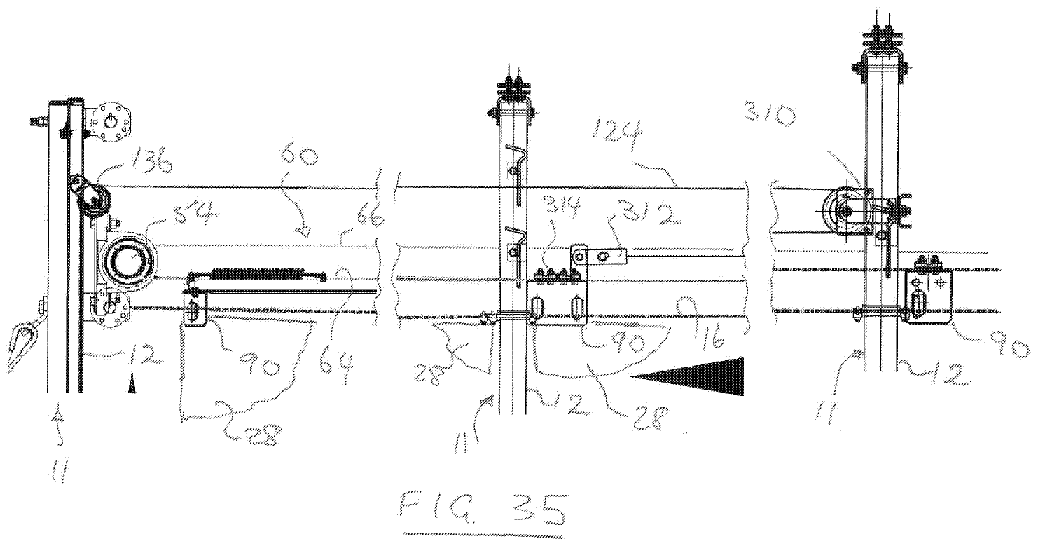

A similar configuration is provided at the distal end of the row R as shown in FIG. 34 with a reversing pulley 316 mounted on the second support structure from the distal end structure 11 and the diverter wire 124 entrained about the pulley 316 and connected to the plate 90 secured to the driven run 64.

In operation, assuming the roof 20 is in an open position, the plate 90 will be positioned adjacent the support structure 11 separating the first and second bays B and the link 312 and its associated plate 90 positioned adjacent the support structure separating the second and third bays B. The drive shaft 54 is rotated to move the driven run and pull the peak toward the leading end structure 11. The link 312 is moved in the same direction by the driven run 64 and causes a corresponding travel of the diverter wire 124. The direction of the diverter wire 124 is reversed by the pulley 310 to move the diverter wire 124 through the pullies 136, 134, 132 and pull the leading edge of the panel 28 at the eave toward the end structure 11.

At distal end, as the driven run 64 pulls the cover to the closed position, the connection of the diverter wire 124 to the driven run 64 moves towards the pulley 316 and the diverter wire 124 is released and passes through the pulleys to allow movement of the panels 28 at the eaves.

Movement of the roof from a closed to open position is the reverse of the above with the retraction of the eaves being initiated by tension in the diverter wire 124 at the distal end with a corresponding release at the leading end.

By adopting the routing of the diverter wire 124 discussed above, it will be noted that there is a relatively short distance between the point of application of the drive force at the peak and the transmission of that motion through the diverter wire to the eaves. By contrast, in the embodiment of FIG. 19, movement of the connection of the diverter wire 124 to the return run 66 is obtained by the application of a force along the driven run 64 from the leading edge to the distal end and back on the return run 66 to the connection of the diverter wire. Because of the significant length of the rows R there is the potential for a significant elongation of the drive cable which may result in misalignment of the peak and eaves at the end of the travel.

To maximize heat retention without the use of flaps as in FIG. 27, FIG. 30 shows the loops 30 from adjacent roofs 28 are connected onto the same valley wire 18 without the use of elastics 29, thus creating a small opening where little heat can escape, but rain can pass. This is possible because the ridge wires are powered by the same drive shaft 50 and the roof sections move conjointly. This permits the loops 30 from adjacent roofs to be connected to the same valley wire 18.

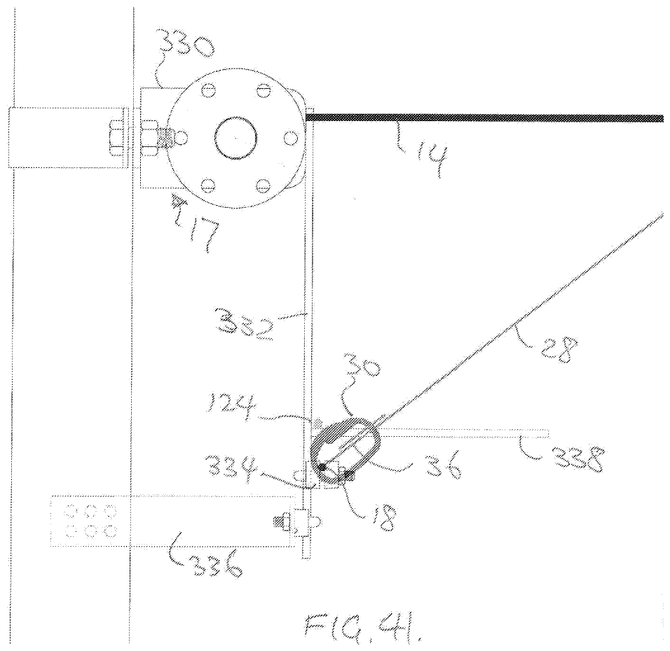

In order to avoid undue friction and wear of the loops 30 as the diverter wire 124 moves along the valley, each of the lower horizontal wires 14 is used to support a cable guide 320 as shown in FIGS. 39 and 40. The cable guide 320 has a horizontal rod 322 that is spaced from the wire 14 by a stack of blocks 324. The rod 322 extends laterally to each of the edges 36 of panels to overlie loops 30 and the diverter wire 124 lies on the upper surface of the rod 322. As the diverter wire 124 is moved, the rod maintains a clearance between the wire 124 and loop to avoid abrasion. There are alternate ways to support the rod 322 above the diverter wire 124 like a U shaped member where the bottom of the U is connected to the block 324 and the vertical legs of the U support the rod 322.

It is desirable that the width of the panel 28 is the same for all locations where the spacing of the support posts 12 from peak to peak is the same. To accomplish this, the horizontal distance from the support post 12 to the valley 18 must be consistent in order for the length of the slope to be the same. In FIGS. 39 and 41, the tightener 17 at the outside wall interferes with the positioning of the cable 18 causing it to be located inboard from the post 12 which would cause the distance from the peak wire 16 to the valley wire 18 to be shorter. If the same width panel was installed on the outside slope adjacent to the outside wall, the roof would be baggy and will suffer mechanical damage due to flapping. In order to have the length of the slope of the panel 28 the same at all locations, the valley wire 18 is repositioned below the horizontal wire 14.

Moreover, in certain situations where multiple crop protection systems are to be arranged side by side it is important that the spacing of the posts 12 is maintained at an industry norm, typically 4000 mm. and 2000 at the outside postline to support ½ of the roof) In that case, the tensioner 17 for the horizontal wires 14 and the eave support wire 18 have to be located inboard of the post 12 so a similar connection can be made on the other side of the post for the adjacent roof system. However, the width of the panel 28 is the same for all panels and to avoid excessive flapping of the panel 28 it is necessary to mount the outside panel differently while still retaining the functionality of the retractable roof 20.

Referring to FIGS. 39 and 41, it can be seen that the lateral edge 36 of the outer panel 28 is connected to the post 12 below the horizontal wire 14. The tensioner 17 has a clevis 330 that is bolted to the post 12. A bracket 332 is welded to the clevis 330 and depends below the guide wire 14 to receive a cable clamp 334. The clamp 334 locates the eave support wire 18 at a position that the distance from the ridge wire 16 to each of the eave guide wires 18 is the same. A hook 30 secures the panel 28 to the eave wire 18 to retain the necessary tension and avoid excessive movement of the panel.

A strap 336 extends from the post 12 to the bracket 332 to provide lateral support for the bracket and maintain the position of the eave wire 18.

A support rod 338 projects laterally inwardly from the bracket 332 above the cable clamp 334 and holds the diverter wire 124 above the hook 30 to avoid abrasion in a manner similar to the rod 312 employed in the valley.

In each of the embodiments, it will be seen that a tensile member is used to transfer motion from one location, typically the peak, to another location, typically the eave so that conjoint movement of the locations is attained. The provision of the tensile member to transfer motion from one location to another enables a single linear drive shaft to be utilised for multiple rows without the need for jointed drive shafts or multiple shafts and related bracing complications. The panels forming the roof are maintained under control when open or closed to enhance the protection offered.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A retractable roof structure having a pair of longitudinally spaced supports, guide wires extending between said supports and positioned to support a covering in a required profile, said covering comprising at least one section slidably supported on the guide wires so as to be moveable between an open position in which the area beneath the covering is exposed and a closed position in which the area beneath the covering is covered, a drive member extending between the supports and operably connected to one end of said at least one section at a first location to move the one end along the guide wires, and a first tensile member to transfer movement of said one end at said first location to a second location spaced from said first location, said first tensile member operably connected to said drive member to move said second location conjointly with said first location, whereby movement of the first location of one section is transferred through the first tensile member to the second location to cause a corresponding movement thereof.

2. The retractable roof structure of claim 1 wherein said covering comprises a plurality of sections arranged in seriatim along the guide wires and each extending between a pair of supports.

3. The retractable roof covering of claim 2 wherein each of said sections is connected at a respective first location to said drive member.

4. The retractable roof covering of claim 3 wherein said first tensile member extends to a respective second location on each of said sections.

5. The retractable roof covering of claim 4 wherein said required profile is a gable roof having an elevated peak extending outwardly and downwardly to a pair of eaves and a respective one of the guide wires is located at the peak and at each of the eaves to constrain the covering to the required profile.

6. The retractable roof covering of claim 5 wherein said drive member is located adjacent to said elevated peak.

7. The retractable roof covering of claim 6 wherein said first location is adjacent the elevated peak and said second location is adjacent respective ones of said eaves.

8. The retractable roof covering of claim 7 wherein said first location and said second location are at the leading edge of each of said sections.

9. The retractable roof of claim 1 wherein a second tensile member extends from the first location to a second location and is operable connected to said drive member to move said second location conjointly with said first location in a direction opposite to that of said first tensile member.

10. The retractable roof of claim 9 wherein the first and second tensile members are continuous.

11. The retractable roof covering of claim 1 wherein said drive member is a cable entrained in a continuous loop between a pair of said supports to provide a driven run and a return run.

12. The retractable roof covering of claim 11 wherein said section is connected to said driven run at said first location for movement therewith.

13. The retractable roof covering of claim 12 wherein said first tensile member passes from said one location to one of said structures and back to said second location so that said first and second locations move conjointly in the same direction.

14. The retractable roof covering of claim 13 wherein said first tensile member is connected to said return run to move in a direction opposite to that of the first location.

15. The retractable roof covering of claim 13 wherein said first tensile member is connected to said driven run to move in the same direction as said first location, said first tensile member initially extending away from said one structure and passing about a direction reversing member to extend subsequently toward said one structure for connection to said second location.

16. The retractable roof covering of claim 8 wherein said first tensile member passes from said one location at said elevated peak to one of said structures and back to said second location at said eave so that said first and second locations move conjointly in the same direction.

17. The retractable roof covering of claim 16 wherein said first tensile member is entrained on said one structure to move along a path extending between said guide wire at said peak to a guide wire at said eave.

18. The retractable roof covering of claim 17 wherein said path is defined by pullies about which said first tensile member is entrained.

19. The retractable roof covering of claim 15 wherein said pullies are located on a rigid support to maintain the spacing between runs of said first tensile member between said locations and said support.

20. A retractable roof structure having a covering extending between pair of longitudinally spaced supports said covering having a profile of a plurality of gables arranged side by side with each gable having an elevated peak extending outwardly and downwardly to a pair of eaves, said cover supported by guide wires extending between said supports with a respective one of the guide wires located at the peak and at each of the eaves to constrain the covering to the required profile, said covering comprising a plurality of sections, each slidably supported on the guide wires so as to be moveable between an open position in which the area beneath the covering is exposed and a closed position in which the area beneath the covering is covered, each of said gables having a drive member extending between the supports and operably connected to one end of a section at a first location to move the one end along the guide wires, and a first tensile member to transfer movement of said one end at said first location to a second location spaced from said first location, said first tensile member operably connected to said drive member to move said second location conjointly with said first location, whereby movement of the first location of one section is transferred through the first tensile member to the second location to cause a corresponding movement thereof, said drive members being connected to a common drive so as to operate conjointly and move sections of each gable in unison.

21. The retractable roof covering of claim 20 wherein adjacent eaves are slidably connected to a common guide wire.

22. The retractable roof covering of claim 21 wherein said second location is located at each of said eaves and said first tensile member is connected to each eave to provide movement of adjacent eaves along said common guide wire.

23. The retractable roof according to claim 22 wherein said tensile member is supported in spaced relationship above said common guide wire by a cable guide.

24. The retractable roof covering of claim 20 wherein each of said drive members is a cable entrained in a continuous loop between a pair of said supports to provide a driven run and a return run.

25. The retractable roof covering of claim 24 wherein each of said drive members is located at a respective one of said peaks above said covering.

26. The retractable roof covering of claim 25 wherein said drive includes a drive shaft extending between said peaks with each of said drive members engaged with said shaft for conjoint operation.

27. The retractable roof of claim 26 wherein a second tensile member extends from the first location to a second location and is operably connected to said drive member to move said second location conjointly with said first location in a direction opposite to that of said first tensile member.

28. The retractable roof of claim 27 wherein said first tensile member and said second tensile member are connected to said driven run to move in the same direction as said first location.

29. The retractable roof of claim 27 wherein said first tensile member and said second tensile member initially extend away from a respective structure and pass about a direction reversing member to extend subsequently toward said structure for connection to said second location.

30. The retractable roof covering of claim 29 wherein each of said tensile members is entrained on a respective structure to move along a path extending between said guide wire at said peak to a guide wire at said eave.

31. The retractable roof covering of claim 30 wherein said path is defined by pullies about which said first tensile member is entrained.

32. The retractable roof covering of claim 31 wherein said pullies are located on a rigid support to maintain the spacing between runs of said first tensile member between said locations and said support.

33. The retractable roof covering of claim 20 wherein each of said supports includes a plurality of laterally spaced posts and lateral support wires extending between said posts at vertically spaced locations, said guide wires at said eaves being connected to said lateral support wires.

34. The retractable roof of claim 33 wherein said guide wires at said eaves are connected to a rigid support extending between said vertically spaced lateral support wires and connected thereto.

35. The retractable roof of claim 34 wherein the connection of said rigid support to said lateral support wire is adjustable to maintain said rigid support vertical.

36. The retractable roof of claim 33 wherein said rigid support member has at least one pulley mounted thereon to guide said first tensile member from said first location to said second location.

37. The retractable roof of claim 33 wherein a laterally outer guide wire at an eave is connected to a post inboard of and below the connection of the lateral support wire to said post.

38. A retractable roof structure having a covering extending between pair of longitudinally spaced supports said covering having a profile of a plurality of gables arranged side by side with each gable having an elevated peak extending outwardly and downwardly to a pair of eaves, said cover supported by guide wires extending between said supports with a respective one of the guide wires located at the peak and at each of the eaves to constrain the covering to the required profile, said covering comprising a plurality of sections, each slidably supported on the guide wires so as to be moveable between an open position in which the area beneath the covering is exposed and a closed position in which the area beneath the covering is covered, each of said gables having a drive member extending between the supports and operably connected to one end of a section at a first location to move the one end along the guide wires, said drive members being connected to a common horizontal drive shaft extending between and located above said peaks so as to operate conjointly and move sections of each gable in unison.

39. The retractable roof of claim 38 wherein said first location is adjacent to said guide wire at said peak.

40. The retractable roof according to claim 39 wherein said drive member is operably connected to said one end of said section at a second location adjacent to said eave guide wire to move said locations conjointly along said guide wires.
